(19) United States
(12) Patent Application Publication
(10) Pub. No.: US 2007/0269041 A1
(43) Pub. Date: Nov. 22, 2007

(54) Method and apparatus for secure messaging

(76) Inventors: Rajat Bhatnagar, Saratoga, CA (US); Travis Skare, Stanford, CA (US); Mathew Cowan, Stanford, CA (US); Christopher Pedregal, Stanford, CA (US)

Correspondence Address: MERCHANT & GOULD PC, P.O. BOX 2903, MINNEAPOLIS, MN, 55402-0903, US

(21) Appl. No.: 11/645,129

(22) Filed: Dec. 21, 2006

Related U.S. Application Data
(60) Provisional application No. 60/753,897, filed on Dec. 22, 2005.

(51) Int. Cl. H04L 9/30

(52) U.S. Cl. 380/30

(57) ABSTRACT

Methods and systems for secure messaging are disclosed. One method includes generating a first key associated with the sender. The method further includes encrypting a message from the sender to the recipient using the first key. The method also includes encrypting the first key with a second key. The method includes storing the encrypted message and the encrypted first key at a message server accessible to individuals including the sender and the recipient. The method includes associating the encrypted message with a sender and a recipient. The method also includes decrypting the encrypted first key using a key related to the second key, and decrypting the encrypted message using the first key. In the method, the message is encrypted on the message server at least while not accessed by the sender or recipient.

### CROSS REFERENCE TO RELATED APPLICATIONS

This application claims priority to U.S. Provisional Patent Application Ser. No. 60/753,897, filed on Dec. 22, 2005, which is incorporated herein by reference in its entirety.

### BACKGROUND OF THE INVENTION

Many problems exist with conventional e-mail systems, protocols and standards. Well known among them are spam, phishing, viruses, worms and other “malware” designed to perform one or more nefarious functions as well as the loss of e-mail in transit due to technical errors or false-positive readings by spam filters. Less well known is the vulnerability of e-mail to interception by unintended recipients who can either read or modify the content.

FIG. 1 shows an exemplary prior art network architecture 100 used in e-mail transmission. In such a configuration, conventional e-mail is transmitted across the internet as unencrypted or “clear” text, traversing multiple private and public servers along the way as it travels through cables or the air (via satellite) over hundreds or thousands of miles. E-mail transmitted across such architectures as clear text can be intercepted, read, and modified by information technology administrators or others with a modicum of technical skill.

These problems are difficult to correct because today's e-mail system has evolved from a technology designed to allow a limited number of professors at different universities to communicate electronically; it was not designed to be a mass-market communication medium and consequently did not include the security measures that are necessary for such pervasive use. The protocols used to support e-mail did not take into consideration the privacy, reliability, and scalability requirements of widespread, modern electronic communication. Unfortunately, this e-mail standard, which is still in use today, cannot be changed without breaking the existing network. To change the current standard, all e-mail servers would have to be upgraded simultaneously—a task that is not feasible.

Because of the importance of e-mail as a communication medium and the significant number and severity of problems facing it, a wide variety of solutions have been developed. The result is an explosion of incompatible and competing spam filters and encryption software products that are far from satisfactory because they are necessarily incomplete and complicated. All of these solutions address just a subset of the challenges; none of the solutions address the fundamental, underlying problems associated with the current standard.

Encryption systems can be difficult to integrate into existing systems and cumbersome to use. Complex mechanisms are required to encrypt messages sent to new users outside of a conventional system because new users do not have public keys associated with their e-mail address. In PGP, for example, new users need to generate key pairs before they can receive secure e-mails.

For these and other reasons, improvements are desired.

### SUMMARY

The above and other problems are solved in accordance with the present disclosure by the following:

In certain embodiments of the invention, systems and methods are provided for building a messaging system that avoids the limitations of existing e-mail systems yet offers the look and feel of conventional e-mail to subscribers. The system of the present disclosure is, in some aspects, based on a message server which manages all messages. When users send or receive messages, these go through the message server.

The present disclosure has several main advantages over regular e-mail: ease of use (particularly when the recipient does not have a secure e-mail solution), end-to-end security, user authentication (senders and recipients can be certain of each other's identity), portability (users can send and receive encrypted, authenticated e-mail from any internet-connected computer), low cost (no need to purchase digital certificates, hardware, or IT resources), limited spam, and confirmation/time-stamping of delivery as well as e-mail opening. Additionally, whenever messages are stored on a remote computing system not controlled by a sender or recipient, the messages are encrypted. Encryption can take place on the sender's computer so that the remote computing system, and preferably any network traffic monitor never “sees” the plain-text message. Encryption can alternately take place on the remote computing system, and persistent storage of the clear text message can be avoided. In either event, even administrators of the remote computing system cannot read messages stored on that system.

In a first aspect, the present disclosure involves a method of secure messaging between a sender and a recipient. The method includes generating a first key associated with the sender. The method further includes encrypting a message from the sender to the recipient using the first key. The method also includes encrypting the first key with a second key. The method includes storing the encrypted message and the encrypted first key at a message server accessible to individuals including the sender and the recipient. The method includes associating the encrypted message with a sender and a recipient. The method also includes decrypting the encrypted first key using a key related to the second key, and decrypting the encrypted message using the first key. In the method of this aspect, the message is not decrypted on the message server at least when not accessed by the sender or the recipient.

In a second aspect, the present disclosure involves a message server accessible to individuals including a sender and a recipient. The message server includes a memory configured to store one or more messages and encryption keys. The message server further includes a programmable circuit operatively connected to the memory and arranged to manage messages between at least one sender and at least one recipient. The programmable circuit is programmed to generate a first key associated with the sender and encrypt a message from the sender to the recipient using the first key. The programmable circuit is also programmed to encrypt the first key with a second key. The programmable circuit is programmed to store the encrypted message and the encrypted first key, and also to associate the encrypted message with a sender and a recipient. The programmable circuit is programmed to decrypt the encrypted first key using a key related to the second key, and also to decrypt the encrypted message using the first key. In this aspect, the message is not decrypted on the message server at least when not accessed by the sender or the recipient.

In a third aspect, the present disclosure involves a method of secure messaging between a sender and an unregistered recipient. The method includes generating at least a first sender key associated with the sender. The method includes encrypting a message from the sender to the recipient using the first sender key, and encrypting the first sender key with a second sender key. The method further includes storing the encrypted message and the encrypted first sender key at a message server accessible to individuals including the sender and the recipient. The method further includes generating a message signature. The method also includes associating the encrypted message with a sender and a recipient, and associating the message signature with the encrypted message. The method further includes decrypting the encrypted first sender key using the second sender key, and encrypting the first sender key using a recipient public key. The method also includes decrypting the encrypted first sender key using a recipient private key and decrypting the encrypted message using the first sender key. In this aspect, the message is not decrypted on the message server at least when not accessed by the sender or the recipient.

In the various embodiments of the present disclosure, communications transmitted between users and the message server are encrypted using SSL. The messages themselves can be encrypted using a 256-bit AES key. This key, in turn, can be encrypted using a 2048-bit RSA key. The third layer alone, RSA, has been considered so secure that it would take millions of years for a $10M computer using technology available in the year 2000 in order to break it.

### BRIEF DESCRIPTION OF THE DRAWINGS

FIG. 1 illustrates a typical architecture of an e-mail messaging system as known in the art;

FIG. 2 shows methods and systems for secure messaging according to a possible embodiment of the present disclosure;

FIG. 3 is an exemplary schematic diagram of a network in which aspects of the present disclosure can be implemented.

FIG. 4 is a block diagram of a system for secure messaging according to a possible embodiment of the present disclosure;

FIG. 5 is a block diagram of an exemplary secure messaging system according to a possible embodiment of the present disclosure;

FIG. 6 is a schematic representation of a computing system that may be used to implement aspects of the present disclosure;

FIG. 7 illustrates a logical software stack usable to implement aspects of the present disclosure;

FIG. 8 illustrates a further possible logical software stack usable to implement aspects of the present disclosure;

FIG. 9 illustrates a further possible logical software stack usable to implement aspects of the present disclosure;

FIG. 10 shows methods and systems for allowing a sender to log in to a system for secure messaging according to various possible embodiments of the present disclosure;

FIG. 11 shows methods and systems for composing and transmitting messages in a system for secure messaging according to various possible embodiments of the present disclosure;

FIG. 12 shows methods and systems for receiving messages in a system for secure messaging according to various possible embodiments of the present disclosure;

FIG. 13 shows methods and systems for subscribing new users to a system for secure messaging according to various possible embodiments of the present disclosure; and

FIG. 14 shows methods and systems for accessing and displaying messages in a system for secure messaging according to various possible embodiments of the present disclosure.

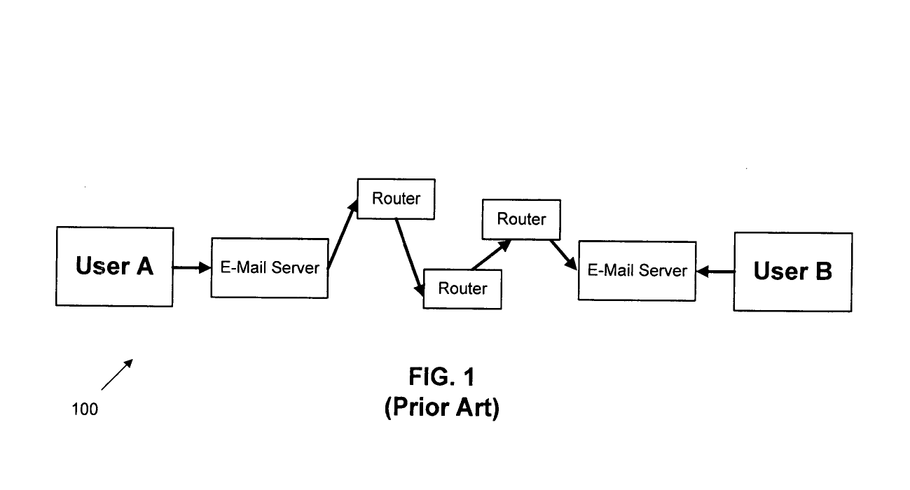

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general the present disclosure relates to methods and systems for secure messaging. The present disclosure can be implemented in a message server, which in turn may be implemented as a secure central computing system that is remote from a sender and a receiver, and is configured to store messages received via a web mail or e-mail application. The messages stored on the central computing system are encrypted so as to prevent third parties, such as internet service providers or others, from accessing the messages during transmission or storage. The methods and systems disclosed herein use a combination of symmetric keys, public/private key pairs, and various encryption and hashing algorithms to ensure message security during transmission and storage.

The present disclosure contemplates situations in which a sender addresses a message to a recipient with an e-mail address that is not registered on the message server. In such an instance, temporary identifiers allow senders to send messages to non-subscribing recipients, securing messages to those recipients through use of temporary encryption keys. Once the recipient registers on or subscribes to the message server, the methods and systems described herein contemplate replacing the temporary keys with newly-generated keys associated with the recipient. The encrypted private keys of the sender and recipient are stored on the message server, and can be accessed and decrypted by the respective sender or recipient through use of that person's login credentials. By storing all of the necessary keys in encrypted form on a widely accessible message server, secure messaging is not tethered to specific computers; by generating temporary keys on behalf of non-subscriber recipients, subscribers can securely send messages to non-subscribers (i.e. before they have subscribed) such that secure messaging can thereby extend to others receiving messages from an existing user of the disclosed methods and/or systems.

In the various embodiments of the present disclosure, communications transmitted between users and the message server are encrypted using SSL. The messages themselves can be encrypted using a 256-bit AES key. This key, in turn, can be encrypted using a 2048-bit RSA key. The AES and RSA encryption may be used to encrypt messages and/or keys stored at a message server, at a client device, or elsewhere in a secure messaging network.

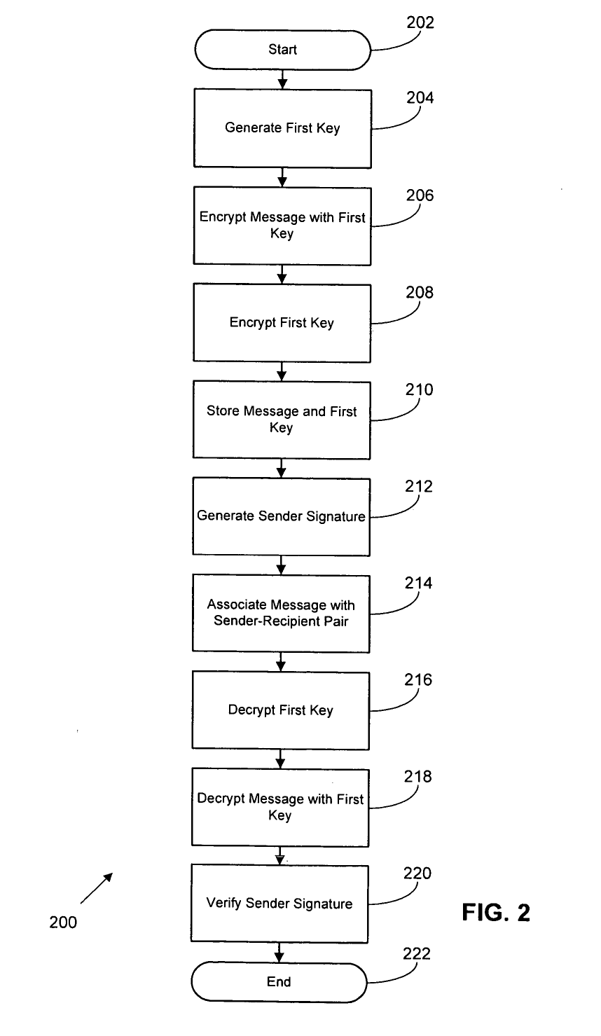

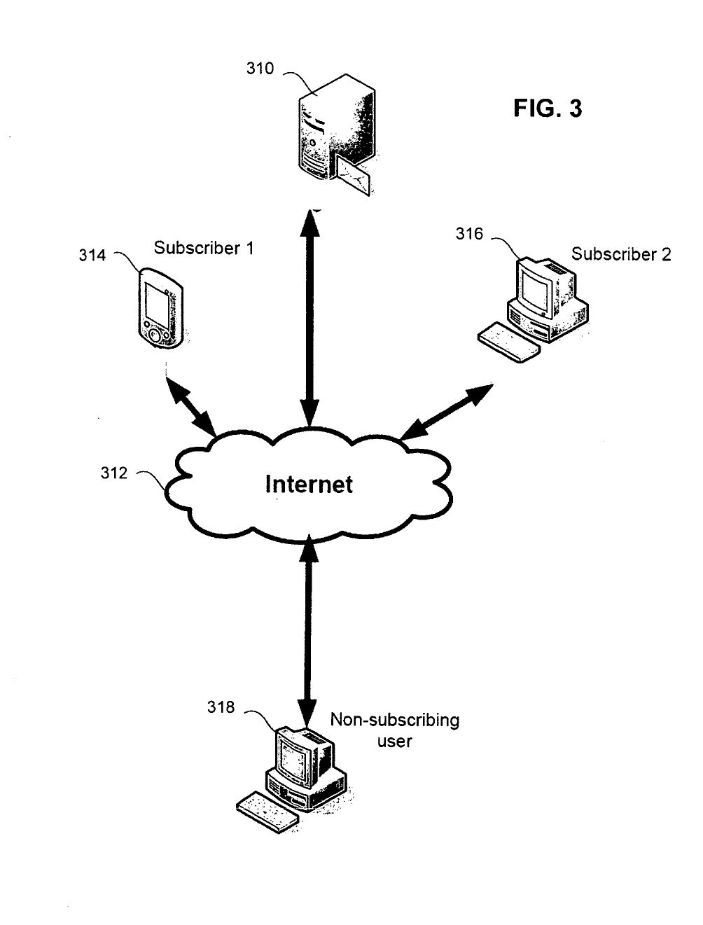

Referring now to FIG. 2, methods and systems for secure messaging are shown according to a possible embodiment of the present disclosure. The system 200 shown provides for secure messaging, such that intermediaries within a communications network are effectively prevented from accessing the content of messages between senders and subscribing or non-subscribing recipients. The system 200 accepts an e-mail or other electronic message composed by a sender, and prepares the message for access by a recipient while preventing access to third parties. The various modules of the system 200, as described below, may be performed by (1) a web application, (2) a message server, such as the message server shown in FIGS. 3-6, or (3) a plug-in for a client e-mail application. Different modules are executed by one or more of these structures, as dictated by the computing loads and architecture of the specific network in which the method 200 operates. However, in all instances, including those where encryption is applied at a message server for storage thereon, locally unencrypted data may be transmitted between the message server and the client device(s) using one or more secure communication protocols to ensure security during data transmission.

The system 200 is instantiated at a start module 202. The start module corresponds to opening a web browser, e-mail application, or otherwise choosing to instantiate the system 200. Operational flow proceeds to a generate module 204. The generate module generates a first key associated with the sender. In one embodiment, the first key is generated using the Advanced Encryption Standard (AES), resulting in a 128-bit, 192-bit, or 256-bit encryption key. Other key lengths and standards are possible as well.

Operational flow proceeds to a message encryption module 206. The message encryption module encrypts the e-mail message received from the sender using the first key generated in the generate module 204. In one embodiment, the message is encrypted using the AES standard.

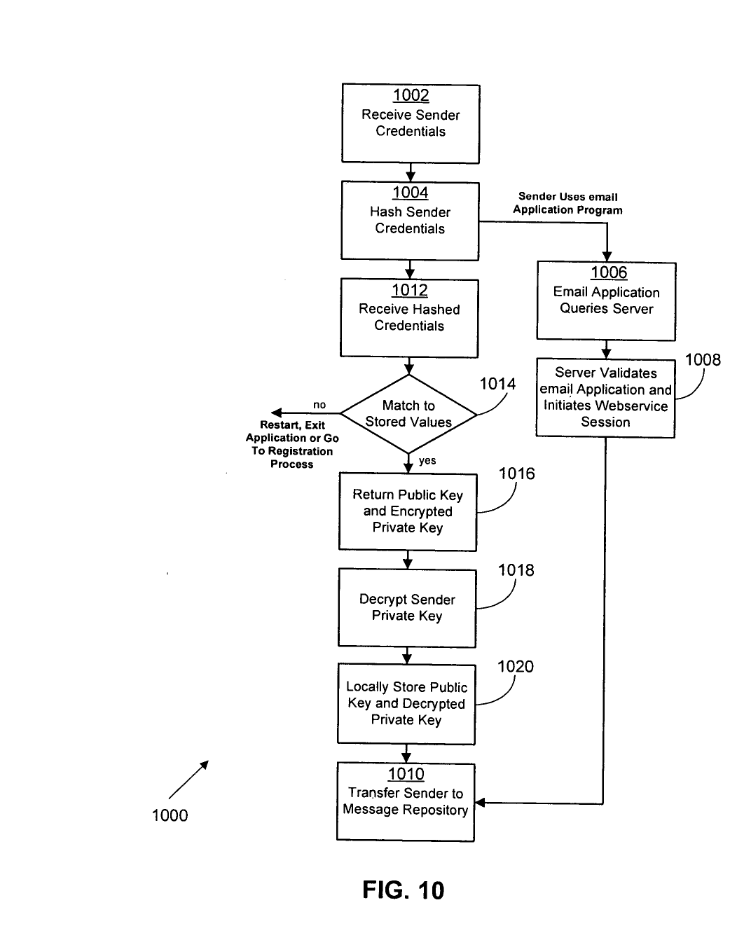

Operational flow proceeds to a key encryption module 208. The key encryption module 208 encrypts the first key associated with the sender with a second key, such that the message cannot be accessed by a third party with access to keys and messages stored on the message server. Various second keys are possible depending upon whether the recipient is a subscriber or a non-subscriber to the message server. If the recipient is a subscriber, the encryption module 208 encrypts the first key with the public key of the recipient which can be stored on the message server. If the recipient is a non-subscriber, a second symmetric key may be used. Various additional possibilities and details of the encryption methods used are described in the example embodiment of FIGS. 10-14, below.

In various embodiments, the encryption performed by the key encryption module 206 and the message encryption module 208 can be performed in a secured web application within a web mail environment. In other embodiments, the encryption can be performed on a message server. In one or both embodiments, the key and message transferred to the message server are encrypted during transmission using any of various secure transmission protocols, such as secure socket layer (SSL) transmission.

Operational flow proceeds to a storage module 210. The storage module 210 stores the encrypted message and the encrypted first key in a memory associated with the message server. In various embodiments, the memory can be any of a number of volatile or nonvolatile memories, and can be implemented as combined or separate message and key databases, or other hierarchical or non-hierarchical data organization schemes.

Operational flow proceeds to an optional signature generation module 212. The signature generation module 212 generates a message signature associated with the sender of the e-mail message by hashing the message and then encrypting the hashed message with the private key of the sender. By using the corresponding public key associated with the sender, a recipient of the message can be sure that the message has not been altered since it was sent by a person with access to the sender's private key. In one embodiment, encryption with the private key uses an RSA encryption algorithm. Other encryption techniques are possible as well.

Operational flow proceeds to an association module 214. The association module associates the message to both the sender and the recipient. Messages sent to recipients who are not currently subscribers to the system 200 can thereby receive messages. Optionally, the association module 214 also associates the message signature with the message. The association module 214 also optionally associates the message signature with the sender's public key at the time that the sender chooses to send the message. If the sender's public key changes later in time, this association to the prior public key will stay the same to match the sender's private key at the time of encryption.

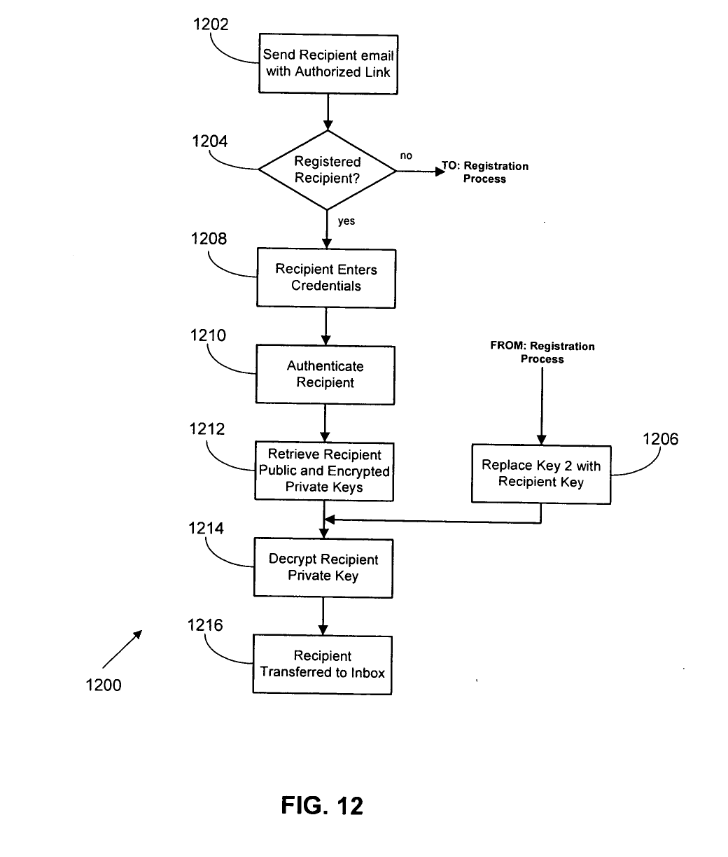

Operational flow proceeds to a key decryption module 216. The key decryption module 216 executes when the recipient wishes to access the message. The key decryption module 216 decrypts the key originally encrypted in the key encryption module 208, using either the recipient's private key or a key associated with the second key, depending on whether the recipient is a subscriber or nonsubscriber of the message server. If the recipient is a subscriber, the key associated with the second key may be the recipient's private key, and the second key may be the recipient's public key. If the recipient is not a subscriber, the key associated with the second key may be the second key itself, and may be a key symmetric to the first key. This second symmetric key may be replaced by the recipient's public key once the recipient registers with the message server. One example of such replacement is discussed below in conjunction with FIG. 12.

Operational flow proceeds to a message decryption module 218. The message decryption module 218 decrypts the message using the now-decrypted first key, which was decrypted in the key decryption module 216. The message decryption module 218 results in a clear text message that can be displayed to the recipient.

Operational flow proceeds to an optional verification module 220. The verification module 220 verifies the message signature by using the combination of the unencrypted message text and the public key of the sender. The public key of the sender can be used in combination with the message signature generated in the signature generation module 212 to decrypt the signature, which is compared to a second hash based on the decrypted message from the message decryption module 218 and the public key of the sender. By matching the signature decrypted with the sender's public key to the received message, the recipient can verify that the message has not been altered since it was sent by the sender (assuming that the sender is the only holder of the sender's private key).

Operational flow terminates at an end module 222.

### A. Exemplary Message Server Network

FIG. 3 is an exemplary schematic diagram of a network in which aspects of the present disclosure can be implemented. In the system 300 shown, a message server 310 facilitates secure e-mail communication between various types of e-mail clients, including web mail clients, installed on devices that can include computers 316 and wireless devices 314 such as Blackberry, Treo, Palm, Microsoft Windows Mobile devices, and cell phones. The message server 310 can also provide registration services that allow or encourage nonsubscribers using devices 318 to register based on receipt of a secured e-mail message, or can allow the nonsubscribers to otherwise receive e-mail using the system 300 without those recipients being required to pre-register with the server 310. Secured messages exchanged between the subscriber devices 314 and 316 can be encrypted using AES, with the AES key in turn encrypted by 2048-bit RSA keys. Additionally, all communications between one of the subscriber devices 314, 316 and the message server 310 can be encrypted using any available point-to-point encryption system such as Secure Socket Layer (SSL).

Subscribers to the message server 310 can select among a plurality of encryption options by selecting one of a variety of access interfaces to the message server. For example, subscribers may select between encryption services provided by preconfigured e-mail clients on the secured devices 314 and 316 or can opt to have server 310 provide encryption service. Differences in distributed encryption may occur within the system 300 based on, for example, the method by which a subscriber accesses the message server 310, as described in the various examples below. Local encryption services offer security by performing all encryption and decryption on a user computer 316 or other e-mail client 314 such that at no time is the message in a clear text format except on the sender or recipient's device. Server-based encryption offloads some computation complexity, and encrypts information in transit to the message server 310, with further persistent encryption and decryption to be performed at the message server 310. Server-based encryption is typically selected when local encryption service is unavailable or impractical. Local encryption service may be impractical, for example, on limited capability devices such as cellular telephones or where e-mail applications are incompatible with the encryption methods used or when a browser or application does not support the encryption software used.

When a subscriber or other user relies on the message server 310 to perform certain encryption services, it is typical that the most complex or processor-intensive encryption services are delegated. Thus, the existing basic encryption methods such as SSL are employed to provide secured communication between device 314, 316 and the message server 310. Typically, the most secure encryption method available to the e-mail client is used. In the SSL example, a 256-bit key may be employed.

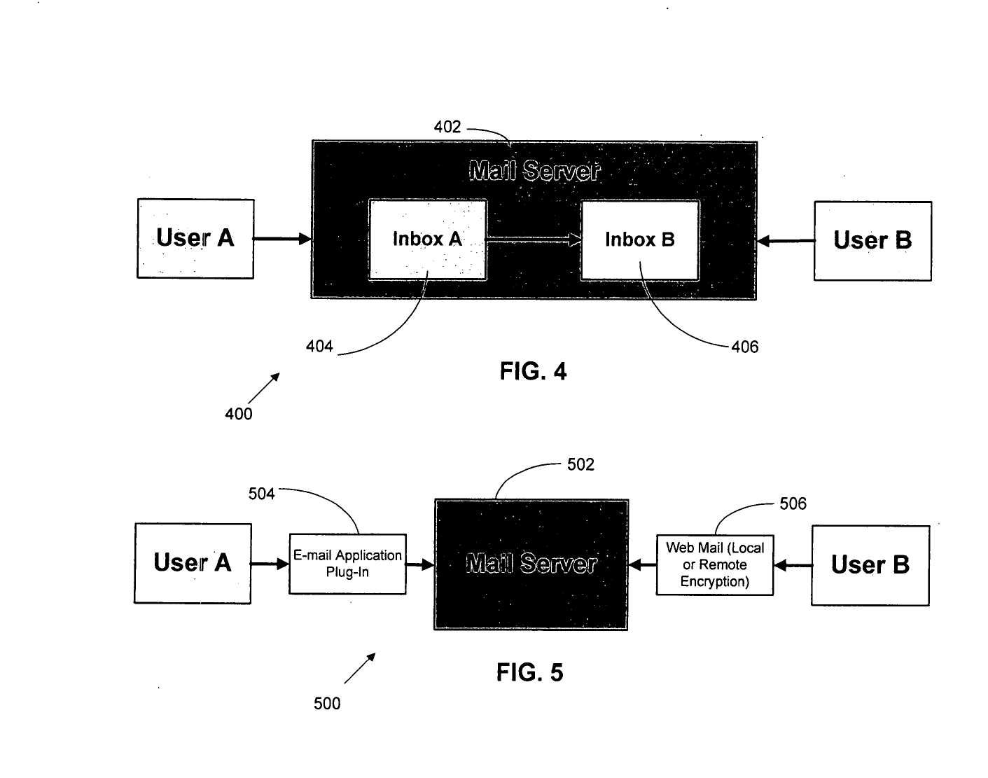

FIG. 4 is a block diagram of a system 400 for secure messaging according to a possible embodiment of the present disclosure. The system 400 illustrates a basic exemplary architecture in which a sender (“User A”) and receiver (“User B”) can transmit and receive secure messages. The system 400 includes a message server 402, which includes first and second message repositories 404, 406. These message repositories can include an “inbox” or a “sent mail” folder as is commonly referred to in various e-mail client applications. The first message repository 404 relates to “User A”, and the second message repository 406 relates to “User B”. Messages held in User A's message repository and designated for transmission to User B are internally transferred within the message server 402 from the first repository 404 to the second repository 406. When User B checks his messages, the message from User A appears in his message repository 406.

In various additional embodiments, the message server 402 includes one or more computing systems. Optionally, the message server connects to one or more external computing systems incorporating memories configured to store one or more message repositories, in addition to or replacement for the memory resident on the message server.

FIG. 5 is a block diagram of an exemplary system 500 for secure messaging according to a possible embodiment of the present disclosure. The system 500 allows User A and User B to exchange secure messages using a messaging server 502. The messaging server 502 interfaces with either an e-mail client application 504 or a web mail application 506 (in a remote or local encryption mode). User A and User B can choose any of these interfaces for composing and receiving messages. In the instance of the e-mail client application 504, a plug-in may be provided for installation with the application to preserve the appearance and action of the e-mail application. In the instance of the web mail application 506, the complete application functionality is present in the web mail application, which is accessible by any of a number of web browsers, such as Internet Explorer, Mozilla Firefox, Opera, or any other similar web browser.

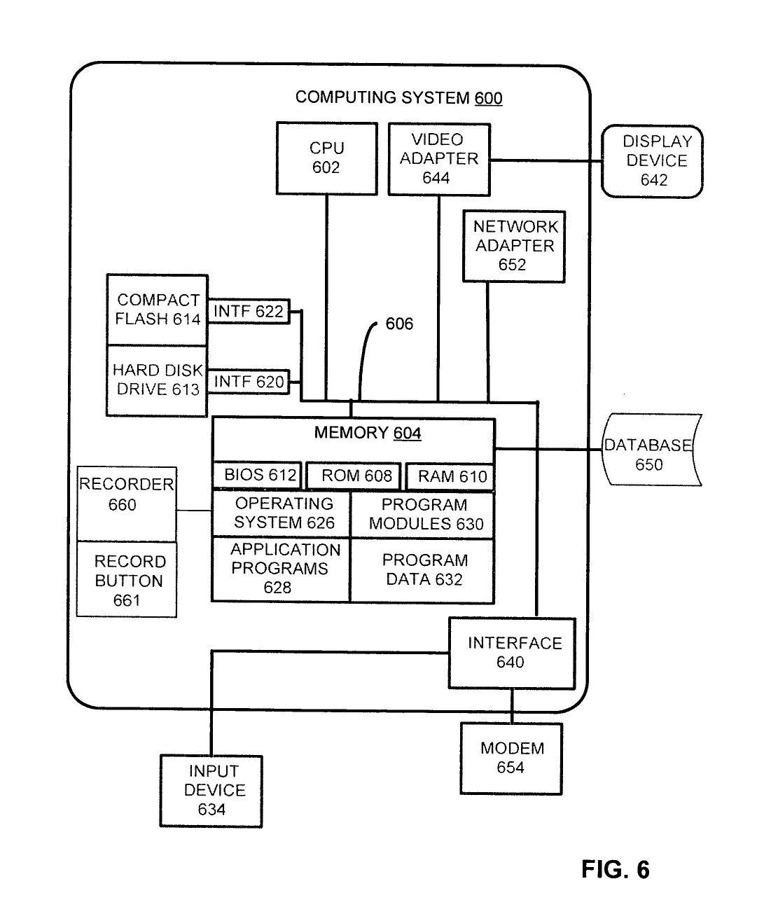

Referring now to FIG. 6, an exemplary environment for implementing various aspects of the present disclosure, such as the messaging server or client devices, includes a general purpose computing device in the form of a computing system 600, including at least one processing system 602. A variety of processing units are available from a variety of manufacturers, for example, Intel or Advanced Micro Devices. The computing system 600 also includes a system memory 604, and a system bus 606 that couples various system components including the system memory 604 to the processing unit 602. The system bus 606 might be any of several types of bus structures including a memory bus, or memory controller; a peripheral bus; and a local bus using any of a variety of bus architectures.

Preferably, the system memory 604 includes read only memory (ROM) 608 and random access memory (RAM) 610. A basic input/output system 612 (BIOS), containing the basic routines that help transfer information between elements within the computing system 600, such as during start up, is typically stored in the ROM 608.

Preferably, the computing system 600 further includes a secondary storage device 613, such as a hard disk drive, for reading from and writing to a hard disk (not shown), and/or a compact flash card 614.

The hard disk drive 613 and compact flash card 614 are connected to the system bus 606 by a hard disk drive interface 620 and a compact flash card interface 622, respectively. The drives and cards and their associated computer readable media provide nonvolatile storage of computer readable instructions, data structures, program modules and other data for the computing system 600.

Although the exemplary environment described herein employs a hard disk drive 613 and a compact flash card 614, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 613, compact flash card 614, ROM 608, or RAM 610, including an operating system 626, one or more application programs 628, other program modules 630, and program data 632. A user may enter commands and information into the computing system 600 through an input device 634. Examples of input devices might include a keyboard, mouse, microphone, joystick, game pad, satellite dish, scanner, digital camera, touch screen, and a telephone. These and other input devices are often connected to the processing unit 602 through an interface 640 that is coupled to the system bus 606. These input devices also might be connected by any number of interfaces, such as a parallel port, serial port, game port, or a universal serial bus (USB). A display device 642, such as a monitor or touch screen LCD panel, is also connected to the system bus 606 via an interface, such as a video adapter 644. The display device 642 might be internal or external. In addition to the display device 642, computing systems, in general, typically include other peripheral devices (not shown), such as speakers, printers, and palm devices.

When used in a LAN networking environment, the computing system 600 is connected to the local network through a network interface or adapter 652. When used in a WAN networking environment, such as the Internet, the computing system 600 typically includes a modem 654 or other means, such as a direct connection, for establishing communications over the wide area network. The modem 654, which can be internal or external, is connected to the system bus 606 via the interface 640. In a networked environment, program modules depicted relative to the computing system 600, or portions thereof, may be stored in a remote memory storage device. It will be appreciated that the network connections shown are exemplary and other means of establishing a communications link between the computing systems may be used.

The computing system 600 might also include a recorder 660 connected to the memory 604. The recorder 660 includes a microphone for receiving sound input and is in communication with the memory 604 for buffering and storing the sound input. Preferably, the recorder 660 also includes a record button 661 for activating the microphone and communicating the sound input to the memory 604.

A computing device, such as computing system 600, typically includes at least some form of computer-readable media. Computer-readable media can be any available media that can be accessed by the computing system 600. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 600.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

### B. Operational Characteristics

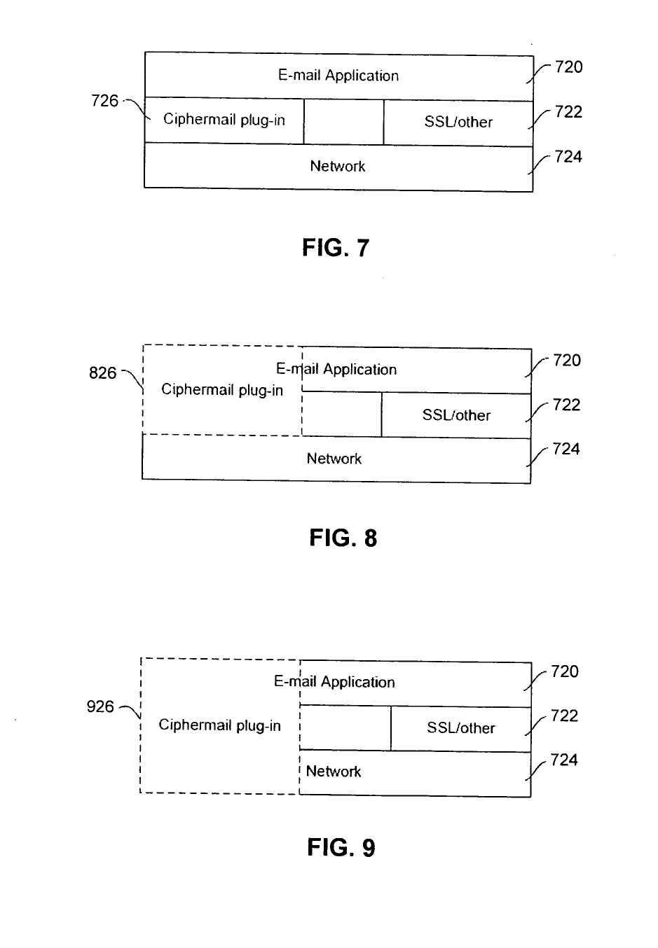

Referring now to FIGS. 7-9, various possible logical software stacks are useable to implement aspects of the present disclosure. Using either a web mail system (using local or centralized, remote encryption) or an e-mail client application, client software may be used to implement aspects of the systems described herein. In one possible embodiment, a web application creates a secure connection to a message server, as described above in conjunction with FIGS. 3-6. In such an embodiment, the web application can be a largely self-contained application sent to the user over a network when that user visits the appropriate network address using a web browser.

Various other possible embodiments provide a plug-in that adds encryption and decryption capability to an e-mail client application. The plug-in augments or supplants certain functionalities of an existing e-mail client installed on user device 314 or 316. For some e-mail clients, complete replacement may be required.

FIGS. 7-9 illustrate three simplified plug-in types which are shown in connection with an e-mail client application, but it is understood that similar implementations are possible with other web and local applications. The various embodiments of the plug-in described herein may be implemented as a Java™ applet integrable into an e-mail client application or web interface. Other implementations of the plug-in are possible as well.

FIG. 7 illustrates that principal components 720, 722 and 724 of a client e-mail system can be augmented with plug-in 726. In this example, the e-mail application user interface 720 and network 724 components are largely unaffected by addition of the plug-in 726, which typically operates by intercepting messages passed from the e-mail application to the network. In the example shown in FIG. 8, a plug-in 826 replaces at least a portion of an e-mail application 720 to ensure that messages are redirected through the plug-in 826. In the example shown in FIG. 9, portions of the e-mail application and Network layer 724 may be replaced to support communication of encrypted messages. In some embodiments, plug-in 926 may utilize pre-installed security software 722, including SSL, for example. However, in many embodiments, plug-in 926 can include SSL components that are used exclusively with the plug-in 926 or that can be made available to other applications operating in the device. Other implementations of the plug-in are possible as well, and depend upon the application programming interface (API) of the e-mail client application with which it is intended to be used.

Referring back generally to FIG. 7, in the example of Microsoft Outlook e-mail, an Outlook plug-in 726 can be constructed using Outlook's built-in architecture for plug-in support. Plug-ins 726 typically handle the entire encryption process and the transmission and reception processes. When the system notifies the user e-mail application 720 that an e-mail has been received for the user, the plug-in 726 may connect to a central server 310 (in FIG. 3, above) using network service 724 and download and cause the message to be displayed. The message can be displayed in a form supported by e-mail client 720, and can include, for example, subject and sender information.

In certain embodiments, the Outlook plug-in 726 may operate to connect to a completely separate system using a non-standard (i.e. non-SMTP) protocol without modifying the display of the e-mail such that a consistent “look-and-feel” is maintained. However, the e-mail control systems described herein permit significantly improved security over current systems. In these embodiments, e-mail may be stored as encrypted messages in both local and server directories and/or databases by each of the communicating subscribers (i.e. senders and recipients) to the system.

Referring generally to FIGS. 10-14, various embodiments of systems for composing, encrypting, transmitting, and storing e-mail messages are described. The various embodiments include software or hardware modules which may reside on one or more message server or client devices, such as are shown above in FIGS. 3-6. In various of these embodiments, distribution of the software modules dictates that encryption techniques may be applied at one or more of these devices depending upon the interface selected by the user to access messages. In instances where encryption is applied at the message server for storage thereon, encrypted data may be transmitted between the message server and the client device(s) using one or more secure communication protocols, such as a Secure Socket Layer (SSL) connection. Although this aspect of the below systems is referenced where particularly applicable in the Figures, additional details of various implementations are discussed in the examples of Part C, below.

Referring now to FIG. 10, methods and systems for allowing a sender to log in to a system for secure messaging are shown according to a possible embodiment of the present disclosure. The system 1000 shown corresponds to a sender logging in to a secure messaging system in preparation for composition of a message to a recipient. The system 1000 is instantiated by the sender, such as by launching an e-mail application or by accessing a web mail client in a web browser.

A credential receipt module 1002 accepts the sender's credentials, which generally include a username and password. The client system generally either requests that the sender provide their credentials, or already has a portion of the sender's credentials, such as that user's e-mail address, stored. In one embodiment, an interface associated with an e-mail client generates a dialog box requesting the subscribing user's credentials. In another possible embodiment, a dialog box or web form field presented in a browser window for the locally or remotely encrypting web mail interface requests the subscribing user's credentials. In another possible embodiment, a federated credentialing system built into the client system, such as at the operating system level, may populate the credential fields in either the e-mail client or the web mail client interface.

Operational flow proceeds to a hash credentials module 1004, which hashes the sender's credentials for encryption. In one possible embodiment, the hash credentials module 1004 uses a SHA256 algorithm as the hash function to form a 32 byte array. When the locally encrypting web mail interface or the e-mail client application is used by the sender, the hash credentials module 1004 executes in the client device 314 or 316. When the remotely encrypting web mail interface is used, the hash credentials module 1004 executes in the message server, described above. In various of these embodiments, a second hash is created by duplicating the sender's password and hashing the result.

At this point in the log in process, operational flow depends on the interface selected by the sender. If the sender is using the e-mail client application, operational flow proceeds to a query module 1006. The query module 1006 queries the message server via a Secure Socket Layer (SSL) connection to validate the identity of the sender. Operational flow proceeds from the query module 1006 to a validation module 1008, which corresponds to validation of the sender's subscriber credentials (username and hash of user name and password) and initiation of a secure messaging session using the message server. The hashed username and password can be compared to stored hash values to locate a matched subscribing user of the message server based on records held in the message server memory. If successful, the second hash formed from the password duplicated is used to decrypt the sender's private key which was stored on the server and returned, below.

If, in some event, the client computer is not connected to the message server, yet has a cached copy of the sender's private key stored thereon, a portion of the same generalized techniques/modules can be applied locally at the client system, with the balance of the procedures as well as an additional update procedure occurring once the client computer is connected to the message server to ensure correspondence between the cached client version and the message server's version of the sender's private key.

Operational flow proceeds from the validation module 1008 to a transfer module 1010. The transfer module 1010 corresponds to transfer of user control to display the subscriber's message repository, which may include an inbox, sent items folder, or other folders. Execution of the transfer module 1010 corresponds to successful completion of the log in process, and allows the sender to compose and send messages as desired. In this operational flow, the sender uses his selected e-mail client application.

If the sender uses either the locally or remotely encrypting web mail interface, operational flow proceeds to a credential receipt module 1012. The credential receipt module 1012 corresponds to the message server receiving the username and the hashed information from the hash module 1004 via a Secure Socket Layer (SSL) connection. In an embodiment of the locally encrypting web mail interface, the now-received subscriber credentials are encrypted via AES prior to transmission to the message server. In an embodiment of the remotely encrypting web mail interface, the received subscriber credentials are encrypted via AES once received by the message server over an SSL connection. Other encryption and data transmission protocols are possible as well.

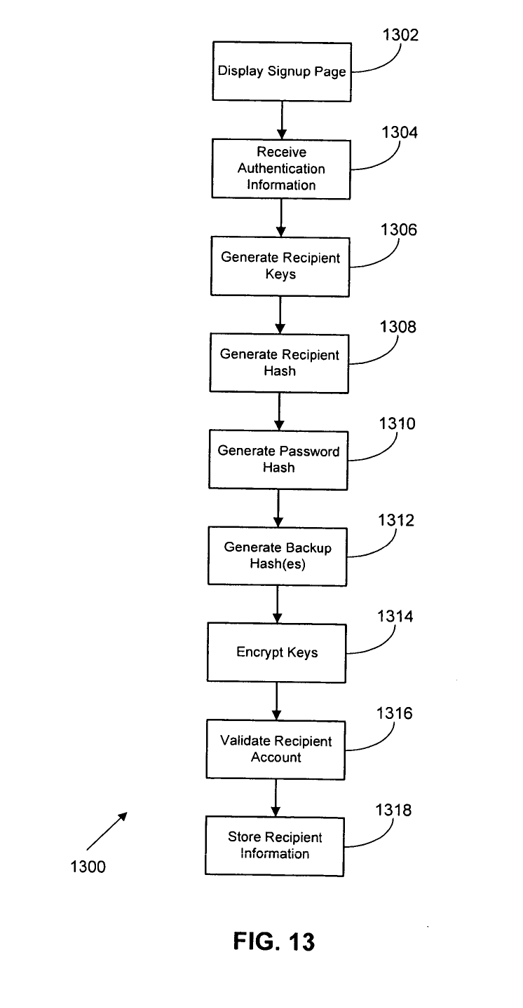

Operational flow proceeds to a comparison operation 1014. The comparison operation 1014 determines whether the received encrypted user name and hash value match those stored in the database for a user. If the comparison operation determines that a match exists, operational flow branches “yes” to a return module 1016, described below. If the comparison operation 1014 determines that a match does not exist, operational flow branches “no” to either (1) restart the log in process, (2) exit the system 1000, or (3) proceed to a subscription process, such as the exemplary subscription process described below in conjunction with FIG. 13. In one possible embodiment, the system may restart a predetermined number of times, allowing the user to correct his login credential entry, if entered inaccurately. Following the predetermined number of log in attempts, the system 1000 may exit or proceed to the subscription process. The system 1000 may also optionally lock the subscriber's account and/or notify the subscriber of the attempted accesses.

The return module 1016 returns the subscriber's public key and encrypted private key to the user. The return module 1016 executes by returning the result from the comparison operation 1014 in the message server, comparing the hashed username and password to stored values to determine whether the user is a subscriber to the message server.

Operational flow proceeds to a decryption module 1018. The decryption module 1018 decrypts the sender's private key using the hash of the sender's password (duplicated) which was initially used to encrypt the key. An exemplary difference between use of the remote and local encryption web mail interfaces may occur in the system of FIG. 10 at this point in the operational flow. When using the locally encrypting web mail interface, the private key is encrypted during transmission to the web interface, and is decrypted by the client computer. When using the remotely encrypting web mail interface, the private key is decrypted by the message server. In both instances, secure transmission of the key to the user is accomplished via an SSL connection.

Operational flow proceeds to an optional storage module 1020. The storage module 1020 may execute in the case of the locally encrypting web mail client, and temporarily stores the decrypted public and private keys in the memory of the locally encrypting web mail client. Operational flow then proceeds to the transfer module 1010. The transfer module 1010, analogously to the e-mail application scenario, transfers the subscribing user to a web message repository, such as a web mail inbox or sent items folder, as appropriate.

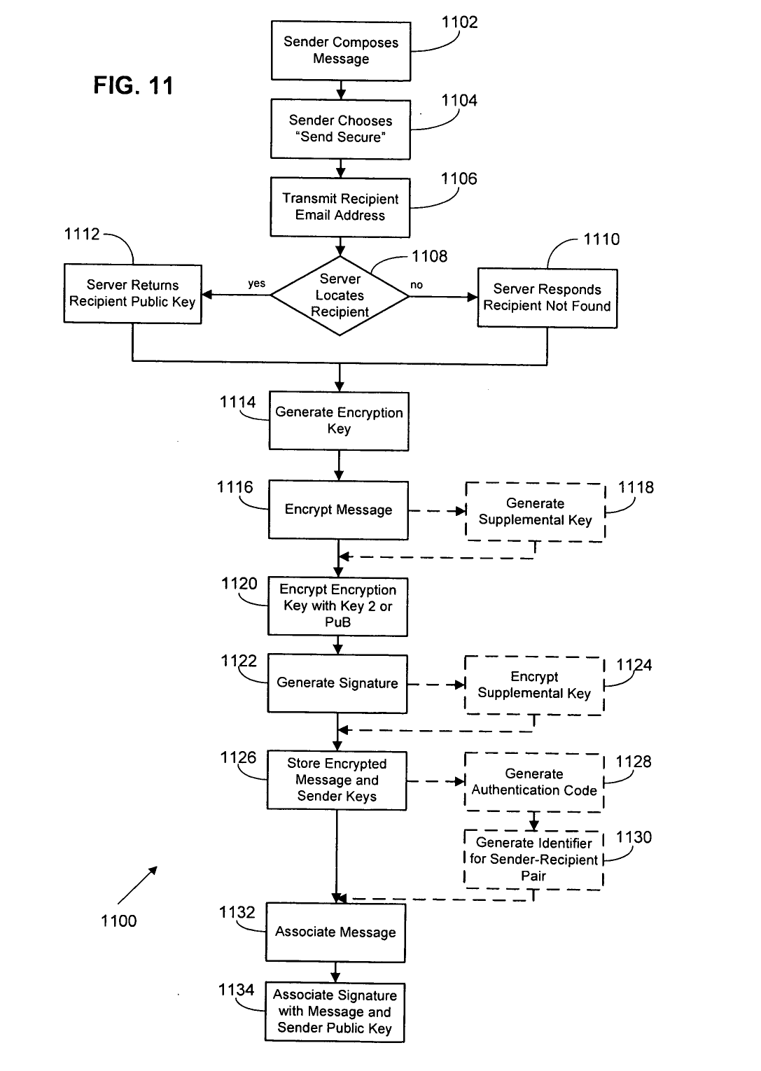

FIG. 11 shows methods and systems for composing and transmitting messages in a system for secure messaging according to various possible embodiments of the present disclosure. The system 1100 provides secure message transmission and storage in the various systems shown in FIGS. 3-6, and corresponds to receipt and storage of e-mail messages sent from a subscriber sender to a recipient who may be a subscriber or a non-subscriber. The system 1100 provides access to messages via a number of interfaces, including an e-mail application and corresponding plug-in, a locally encrypting web mail application, or a remotely encrypting web mail application. The system 1100 generally executes once a log in process has been completed by a sender who is a subscriber of the message server, an example of which is described in conjunction with FIG. 10.

Operational flow in the system 1100 is instantiated at a composition module 1102. The composition module 1102 corresponds to a subscribing user composing an e-mail message and selecting one or more recipients for that message. Operational flow proceeds to a send module 1104, which corresponds to the subscribing user pressing a “send secure” button or some equivalent command to initiate encryption, transmission, and storage of the message on the message server. Operational flow proceeds to an address transmission module 1106, which corresponds to transmission of the recipient's e-mail address to the message server. When using the remotely encrypting web mail interface, the composed message is also transmitted to the message server.

Operational flow proceeds to a recipient location operation 11108. The recipient location operation 1108 determines whether the recipient is a registered, or subscribing, user of the message server. The recipient location operation 1108 uses the recipient's e-mail address received in the address transmission module 1106 to compare to the subscribing users of the message server. In one possible embodiment, the recipient location operation 1108 operates as a query on a user database residing on the message server as described in FIGS. 3-6.

If the recipient is not located by the message server, operational flow branches “no” to a response module 1110, which sends a message to the interfaced client system indicating that there is no subscriber to the message server with a matching e-mail address.

If the recipient is located as an existing subscriber, operational flow branches “yes” to a return module 1112, which returns the recipient's public key. This public key can then be transmitted to the client system from which the sender is accessing the message server via any of the selected interfaces.

Operational flow proceeds to an encryption key module 1114. The encryption key module 1114 generates an encryption key for use in encrypting the e-mail message composed by the sender. The encryption key module may reside on the web application, e-mail client, or the message server. In various possible embodiments, the encryption key is generated using the Advanced Encryption Standard (AES), using a 128-bit, 192-bit, or 256-bit encryption key. Other key lengths and standards are possible as well. Additionally, further keys may be generated by the encryption key module 1114 as well.

Operational flow proceeds to a message encryption module 1116. The message encryption module 1116 encrypts the e-mail message composed by the sender using the encryption key generated in the encryption key module 1114. In one embodiment, the message is encrypted using the AES standard.

If the recipient location operation 1108 determined that the intended recipient is not a subscriber to the message server, operational flow proceeds to a supplemental key module 1118. The supplemental key module 1118 generates a second encryption key, which can be used to encrypt the encryption key generated in the encryption key module 1114. In a possible embodiment, the supplemental key is symmetric to the encryption key, and is generated using the Advanced Encryption Standard (AES), resulting in a 256-bit encryption key. Other key lengths and standards are possible as well.

Regardless of whether the recipient is located in the message server, operational flow proceeds to a key encryption module 1120. The key encryption module 1120 encrypts the encryption key. The key used to encrypt the encryption key depends upon whether the recipient was found in the recipient location operation 1108. If the recipient was found in the message server, the key encryption module 1120 uses the recipient's public key to encrypt the encryption key. If the recipient was not found, the key encryption module 1120 uses the supplemental key to encrypt the encryption key.

The key encryption module 1120 also optionally encrypts the first key with the sender's public key, forming a second encrypted first key. In this embodiment, the second encrypted first key and encrypted message are associated with the sender, as described below, so as to allow the sender access to the sent message, such as by viewing the message in the sender's “sent items” folder, included in the message repository associated with that sender.

Operational flow proceeds to a signature module 1122. The signature module 1122 generates a message signature based on the message text and the sender's private key. In this way, a recipient can use the sender's public key to determine that the message was sent by whomever has control over or access to the complementary private key of the private/public key pair and that the message has not been tampered with in transit. The signature module 1122 may form the message signature by, for example, hashing the message, and encrypting the hashed message using the sender's private key.

If the recipient location operation 1108 determined that the intended recipient is not a subscriber to the message server, operational flow proceeds to a supplemental key encryption module 1124. The supplemental key encryption module 1124 encrypts the supplemental key using the sender's public key. This encryption and storage (in the storage module 1126, below) of the supplemental key allows a recipient who has received more than one secure e-mail from a given sender to decrypt all such e-mails from that sender by clicking on any of the notification e-mails from that sender instead of having to decrypt each message individually by clicking on the link in each notification e-mail individually.

Regardless of whether the recipient is located in the message server, operational flow proceeds to a storage module 1126. The storage module 1126 stores the encrypted message and keys in a memory associated with the message server. When using the locally encrypting web mail interface, the various encryption steps are performed by the web client such that encrypted data is transmitted across the internet to the message server. Therefore, it is possible that when using the locally encrypting web mail interface, the message, keys, and signature reside on a client computing system where the message was generated. In such an instance, the storage module 1126 also corresponds to transmission of the encrypted message, keys, and signature to the message server.

If the recipient location operation 1108 determined that the intended recipient is not a subscriber to the message server, operational flow proceeds to an authentication code module 1128. The authentication code module 1128 generates an authentication code that is to be associated with the recipient in order to prevent their e-mail address from being “hijacked.” The system allows individuals to use their existing e-mail address to send secure e-mail; the authentication code module 1128 prevents, for example, person B from registering with the system using person A's email address. Absent this protection, person B could do so and send and receive secure e-mail using person A's e-mail address.

From the authentication code module 1128, operational flow proceeds to an identifier module 1130. The identifier module 1130 generates a random code that is unique to the sender-recipient pair and is used in all subsequent secure e-mails sent by the sender to a given recipient before the recipient has registered. This code indicates to the system which e-mails to decrypt when the recipient, a new user, clicks on a given notification e-mail received before registering with the message server. Specifically, use of the random code allows the recipient to decrypt all secure e-mails received from a given sender before registering by clicking on the link in just one notification e-mail from that sender instead of having to click on the link in each notification e-mail in order to decrypt the e-mails individually.

Regardless of whether the recipient is located in the message server, operational flow proceeds to a message association module 1132. The message association module 1132, in general, associates and stores the encrypted message and encrypted encryption keys, one for each sender and recipient, on the message server with reference to the sender and recipients. If the recipient location operation 1108 determined that the intended recipient is not a subscriber to the message server, the encrypted supplemental key and pair identification code are associated with both the sender and recipient and stored on the message server.

In a further possible embodiment, the association module 1132 also associates the encrypted message and the first key encrypted with the public key belonging to the sender (i.e. the “second encrypted first key” discussed in the key encryption module 1120, above) with the sender. The sender can then view the e-mail message sent to the recipient in the sender's message repository (i.e. in a sent items folder).

Operational flow proceeds to a signature association module 1134. The signature association module 1134 associates the message signature generated in the signature module 1122 with the encrypted message and the public key belonging to the sender at the time the e-mail message is sent. This allows the system to ensure that the signature, which was created with the private key belonging to the sender at the time the e-mail was sent, can be decrypted at a future point in time, even if the sender has subsequently changed key pairs.

At this point in the system 1100, the sender has been prepared to be “sent” to the recipient, and the message, related necessary keys (sender keys, recipient keys, and temporary keys as necessary), code(s), and signature are securely encrypted as described above and stored on the message server, ready for access by the recipient. The sender may elect to send one or more e-mail messages, which would entail repetition of one or more of the encryption/decryption and message composition modules described above.

Referring now to FIG. 12 methods and systems for receiving messages in a system for secure messaging are shown according to various possible embodiments of the present disclosure. The system 1200 provides secure message receipt and storage in the various systems shown in FIGS. 3-6, and corresponds to receipt and storage of e-mail messages sent from a subscribing sender to a recipient who may be a subscriber or a non-subscriber to a message server, as previously described. The system 1200 4′ operates in web environments, such as the locally or remotely encrypting web mail interfaces discussed above. The system 1200 generally executes once a recipient of an e-mail message (whether a subscriber or non-subscriber) has been sent a secure message via the message server.

Operational flow within the system is instantiated by an e-mail receipt module 1202. The e-mail receipt module 1202 corresponds to an e-mail being sent to a recipient. In the system 1200, the e-mail message sent to the recipient is sent via clear text over SMTP protocols. The e-mail message includes a link having embedded authorization information. The embedded authorization information differs depending upon whether the message server recognizes the recipient as a subscribing user. If the recipient is a subscribing user of the message server, the link will include the recipient's e-mail address, and will link the recipient to a log-in screen. If the recipient is not a subscribing user, the link will have embedded within it a supplemental encryption/decryption key, as well as an authorization code and identification code, such as those generated in the system of FIG. 11. The same encryption/decryption key can be used in all messages sent from the sender to the recipient, allowing a recipient who has received more than one secure e-mail from a given sender to decrypt all such e-mails from that sender by clicking on any of the notification e-mails from that sender instead of having to decrypt each message individually by clicking on the link in each notification e-mail individually.

Operational flow proceeds to a recipient determination operation 1204, which corresponds to the user selecting the link and being routed appropriately. If the recipient is not a subscribing user, operational flow branches “no”, and operational flow proceeds to an optional registration/subscription process by which the non-subscribing user can subscribe to the messaging service. One possible subscription system is described below in conjunction with FIG. 13. The subscription systems contemplated for use in conjunction with the system 1200 require only the recipient's email address and password, and thereby allow users to easily register without providing a large amount of personal information to the message server.

Following the optional subscription process, an optional key replacement module 1206 replaces the supplemental key used to encrypt the first key with a recipient key, such as the recipient public key. In this way, the now-registered recipient can use his private key to access messages in a message repository (i.e. inbox) rather than relying on a link containing a symmetric key for allowing access to the message. This occurs, for example, by decrypting the first encryption key using the second key (symmetric key) and re-encrypting the first key using the recipient's public key. In such a configuration of the key replacement module 1206, re-encryption using the recipient's public key can use an RSA encryption scheme. Operational flow then proceeds to a key decryption module 1214, described below.

If the recipient is a subscribing user of the messaging server, operational flow branches “yes”, and operational flow proceeds to an authorization module 1208. The authorization module 1208 corresponds to the user entering credentials into the web form, and can include presentation of a form requesting specific user credentials or other authorization. The authorization module 1208 accepts various types of credentials from the recipient, such as the recipient's username (i.e. e-mail address) and password. Other credentials are possible as well, such as a backup password or other user-authentication method (IP address, etc.).

Operational flow proceeds to an authentication module 1210. The authentication module 1210 authenticates the user based on the credentials or other authentication provided to the system 1200 in the authorization module 1208. In one embodiment, the authentication module 1210 hashes the username and password of the recipient and compares that and the unhashed username to the stored hashed username, passwords and unhashed username to authenticate the recipient's identity. Operational flow proceeds to a key retrieval module 1212. The key retrieval module 1212 retrieves the recipient's public key and encrypted private key from the message server.

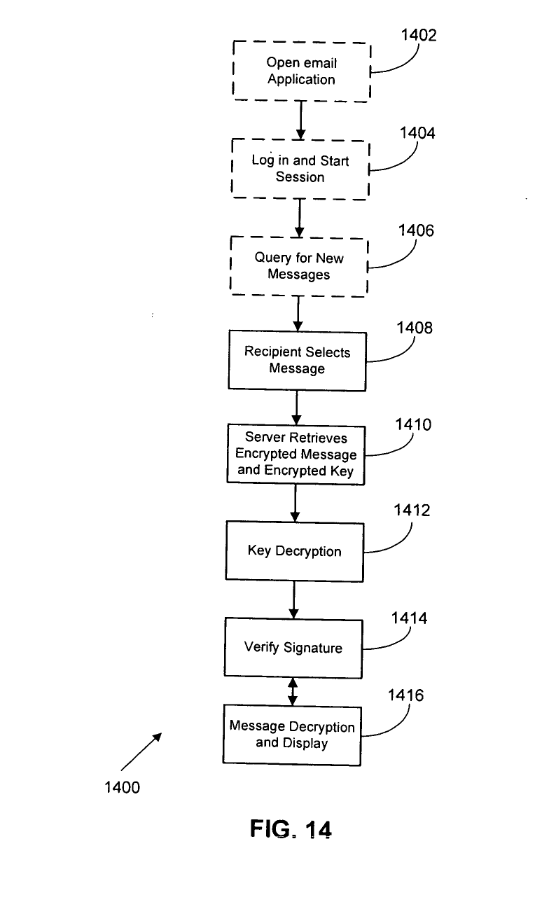

Regardless of whether the recipient is located in the message server, operational flow proceeds to a key decryption module 1214 from either the key retrieval module 1212 or the key replacement module 1206. The key decryption module 1214 decrypts the encrypted private key of the recipient, resulting in an unencrypted recipient private key. At this point, the recipient has recovered their private key, and can decrypt the first key so as to decrypt the message, allowing the recipient to retrieve the message using a message access system, such as the one described below in FIG. 14. Operational flow proceeds to a transfer module 1216 which transfers the recipient to a page in which he can view the contents of his message repository, such as the inbox shown.

FIG. 13 shows methods and systems for subscribing new users to a system for secure messaging according to various possible embodiments of the present disclosure. The system 1300 includes a variety of sequential steps required to cause the system to recognize a subscribing user and to generate keys used by the system which are specific to that subscribing user. The system 1300 is useable in connection with the system 1200 of FIG. 12 in order to “sign up” non-subscribing users of the system who receive messages from subscribing senders of messages via the message server. The system 1300 allows the non-subscribers to subscribe to the message server using an existing e-mail address, thereby not requiring any appearance/use distinction between standard e-mail and e-mail messages communicated consistently with the systems described herein.

Operational flow begins at a display module 1302. The display module 1302 displays signup information to the user in either the web application or a form generated by the plug-in in the e-mail client application. Exemplary information requested from the user includes a username, a password, a backup password or security question (such as “what is your mother's maiden name?”, or some similar question), and an answer to the security question.

Operational flow proceeds to a receipt module 1304. The receipt module 1304 receives user authentication information from the user, who enters information into fields in response to the requests displayed via the display module 1302.

Operational flow proceeds to a key generation module 1306. The key generation module 1306 generates one or more user keys specific to the newly-subscribing user which will be used to verify that user's identity to both the system as well as to recipients of messages sent by the user. Specific keys generated in the key generation module include the recipient's public and private keys, which are used to encrypt and decrypt the encryption key described above in FIGS. 10-11, which in turn encrypts the message received from the sender.

Operational flow proceeds to a recipient hash module 1308. The recipient hash module generates a hash value from the recipient's username and password. The hash including the recipient's username and password is stored on the message server and used to validate subsequent log-ins by the recipient.

Operational flow proceeds to a password hash module 1310. The password hash module 1310 hashes two copies of the password, and that hash will be used to decrypt the recipient's encrypted private key which is stored on the message server. This hashed value is not persistently stored on the server, which therefore prevents users of the server from accessing and decrypting the keys and, consequently, the messages associated with the recipient.

Operational flow proceeds to a backup hash module 1312. The backup hash module 1312 operates analogously to the password hash module, and generates hash values based on (1) the username and answer to the backup question and (2) two copies of the answer to the backup question asked of the recipient during execution of the receipt module 1304. Other combinations of back up hash values are possible as well.

Operational flow proceeds to a key encryption module 1314. The key encryption module 1314 encrypts the recipient's private key generated in the key generation module 1306. In one embodiment, the key is encrypted using the dual-password hash generated in the password hash module 1310. In a further embodiment, the key is also encrypted using the answer to the backup question, hashed twice (similar to the dual password hash).

Operational flow proceeds to a validation module 1316. The validation module 1316 validates the user account by using an authentication code incorporated into the link leading to the display module 1302, such as in the authentication code module 1128 of FIG. 11.

Operational flow proceeds to a storage module 1318. The storage module 1318 stores all of the entered and generated user information obtained during the subscription process. This includes the public key, the private key encrypted using a hash of the password twice, the backup private key encrypted using a hash of the answer twice, and the main and back-up recipient hashes generated by the hash modules 1308 and 1312. This information can be communicated to the message server from the client via SSL connection.

FIG. 14 shows methods and systems for accessing and displaying messages in a system for secure messaging according to various possible embodiments of the present disclosure. The system 1400 includes a number of modules which execute when used in conjunction with an e-mail client application interface, as opposed to a locally or remotely encrypting web mail interface as described above.

When using the e-mail client application interface, various modules execute to access available messages, which provide parallel access interface to the web access interface described above in conjunction with FIG. 12. In the case of the e-mail client interface, operational flow proceeds with an open module 1402. The open module corresponds to a user opening an e-mail client application, such as Microsoft Outlook or Lotus Notes. Operational flow proceeds to a login module 1404. The login module 1404 corresponds to a user entering authentication credentials, such as a username and password. The login module corresponds to the authorization module 1208 operative in the web interface described in FIG. 12, above. Operational flow proceeds to a query module 1406. The query module 1406 corresponds to the e-mail client application and associated plug-in querying the message server to determine if any new messages exist in the message server. The query module can execute in response to a user request, or can be configured to execute automatically (i.e. periodically or triggered upon receipt of a new message).

Following successful execution of the modules 1402-1406 in an e-mail client application or execution of the web access interface as described in conjunction with FIG. 12, both the web and e-mail client interfaces are prepared to decrypt and display the messages available to the recipient. Operational flow proceeds with a message selection module 1408. The message selection module 1408 corresponds to a user selecting a message to read from among the messages contained in that user's message repository (i.e. inbox or sent items folder).

Operational flow proceeds with a retrieval module 1410. The retrieval module accesses and retrieves the encrypted message and the encrypted key associated with the message selected in the message selection module 1408. The message selected and its associated key, both of which are encrypted, are retrieved from memory associated with the client or message server, depending on the recipient's preference settings. The retrieval module 1410 also optionally retrieves the sender's public key and the message signature.

Operational flow proceeds with a key decryption module 1412. The key decryption module 1412 uses the recipient's private key to decrypt the encrypted key received using the retrieval module 1410. In a possible embodiment, the key decryption module uses an RSA decryption scheme to decrypt the encryption key.

Operational flow proceeds to an optional signature verification module 1414. The signature verification module 1414 verifies to the recipient that the holder of the sender's private key sent the message, and that the message has not been altered since it was sent. The message signature was originally formed as an AES-encrypted hash, encrypted using the sender's private key. The signature verification module 1414 can decrypt the encrypted hash using the sender's public key to result in a hash, and can hash the received message from the message decryption module 1416, below, to cross reference with the unencrypted hash (message signature). If the two hashes are equal, the message has not been altered since it was sent by someone with access to the sender's private key.

Operational flow proceeds with a message decryption module 1416. The message decryption module 1416 decrypts the encrypted message received in the retrieval module 1410 using the encryption key decrypted in the key decryption module. This results in a clear text message able to be displayed to the recipient. The message decryption module also optionally transfers the clear text message to a client machine via an SSL-encrypted connection, and displays the e-mail message in clear text to the user. If the optional signature verification module 1414 is used and detects a mismatched signature as described above (and in the below implementations), the message decryption module 1416 may not display the message.

The various modules of FIGS. 10-14 can execute using one or more of the message server or client computers hosing the client interfaces described above (e-mail client or web mail interfaces). Specific operation of various interfaces and embodiments of the present invention are illustrated in the non-limiting examples below.

### C. Exemplary Implementations

As described in detail above, various methods of accessing the message server may be used by its subscribers and recipients of messages from those subscribers. Furthermore, the recipient of messages sent by a subscribing sender may be a subscriber or non-subscriber recipient. Consequently, many permutations of sender-recipient and access methods can be contemplated. For each permutation, different combinations of procedures can be followed, as described in the above embodiments, to ensure reliable transfer of encrypted messages. Table 1 below illustrates some of the combinations supported in various embodiments of the invention.

TABLE 1

| | | Recipient | | | | |
|---|---|---|---|---|---|---|
| | | Nonsubscriber | Subscriber | Nonsubscriber | Subscriber | |
| | | Locally | Locally | Remotely | Remotely | |
| | | Encrypting | Encrypting | Encrypting | Encrypting | e-mail |
| Scenarios | | Web mail | Web mail | Web mail | Web mail | application |
| Sender | Locally | 1 | 2 | 3 | 4 | 5 |
| (Subscriber) | Encrypting | | | | | |
| | Web mail | | | | | |
| | Remotely | 6 | 7 | 8 | 9 | 10 |
| | Encrypting | | | | | |
| | Web mail | | | | | |
| | e-mail client | 11 | 12 | 13 | 14 | 15 |
| | application | | | | | |

In Table 1, each of 15 scenarios represents a combination of subscriber to subscriber or non-subscriber and respective e-mail access methods. These permutations are examples of many permutations supported in various embodiments of the invention and are provided for illustrative purposes only. Thus, the permutations describe combinations of standalone client e-mail applications such as Microsoft Outlook and web mail clients that are designated as locally encrypting clients or remotely encrypting clients. Typically, a locally encrypting web mail client includes code, such as in a plug-in (for example, a Java™ applet), which implements encryption processes provided by the aspects of the present invention. Remotely encrypting Web mail clients use limited or no encryption for communications with a message server, but the message server typically provides encryption in place of the web application.

For the purpose of illustration, login, typical message creation, and receipt procedures are provided for each of the scenarios described above in Table 1. Table 2 below lists the acronyms and abbreviations used in these examples of scenario processes.

TABLE 2
Key to Scenario Process Examples

| | |
|---|---|
| M | clear text message |
| ME | encrypted message, encrypted using AES |
| PuA | Sender's public key |
| PrA | Sender's private key |
| PrAE | encrypted version of sender's private key |
| PuB | Recipient's public key |
| PrB | Recipient's private key |
| A1 and A2 | symmetric keys, generating using AES |
| A1E | encrypted A1, encrypted with A2 using RSA |
| A1EB | A1 encrypted with PuB using RSA |
| A1EA | A1 encrypted with PuA using RSA |
| RID | random ID generated by message server (used to |
| | associate account pairs, sender and recipient, in |
| | case sender sends multiple messages to recipient |
| | before recipient subscribes) |
| AUTH | authentication code generated by message server (sent |
| | out via SMTP to a normal e-mail account used to |
| | make sure that only the owner of an e-mail address |
| | can generate an account on behalf of that account) |
| MHA | hash of M done by A |
| MHB | hash of M done by B |

The following examples describe exemplary operation of the systems of the present disclosure, and provide a detailed functional description of possible implementations of the above-described system. These examples are intended to be illustrative, as there may be various alternative implementations consistent with the present disclosure. The examples are generally divided into subsections related to (1) a sender logging in to the system, (2) composition and preparation of a message for viewing by a recipient, and (3) a recipient accessing the message. These three subdivisions of the system of the present disclosure correspond generally to FIG. 9, FIGS. 11-13, and FIG. 14, respectively.

It is noted that in each of the scenarios, during the various instances in which data is transferred between a client application (web or e-mail client) and the message server, an additional level of encryption based on SSL is applied. The SSL encryption “wrapper” is removed at either end upon receipt by the client or message server, respectively, while any additional encryption applied to the data remains present.

Scenario 1: a [Subscriber, Locally Encrypting Web Mail Mode] E-Mails B [Non-Subscriber, Locally Encrypting Web Mail Mode]

Log In
1. A enters his or her own username and password
2. A's applet hashes (user name, pw) into H1A, a 32-byte array, using SHA256 as algorithm for hash function
3. A's applet hashes (pw, pw) into H2A, a 32-byte array, using SHA256 as algorithm for hash function
4. A's applet transmits H1A to message server using http and SSL
5. Message server compares user name and H1A hash value against the stored database values
6. If successful, message server returns PuA and PrAE [PrA was originally encrypted using AES with H2A as the AES key at the time that A's key pair was issued, typically during registration]
7. A's applet decrypts PrAE into PrA using AES and H2A as the AES key and temporarily stores PrA and PuA in applet's memory. The data in memory is deleted when the user either logs out or closes the browser.
8. A is transferred to inbox page where he can compose message (i.e. login is complete)

Message Composition
9. A clicks compose message
10. A composes message M to B and hits “send secure”
11. A's applet transmits B's e-mail address, querying server for PuB
12. Server responds that there is no user with this e-mail address in the system
13. A's applet generates AES key A1
14. A's applet encrypts message M with A1 using AES, creating an encrypted message (ME)
15. A's applet generates AES key A2 and encrypts A1 into A1E with A2. If B were already in the system, instead of using A2 to encrypt A1 it would use PuB to encrypt A1.
16. A's applet encrypts A1 into A1EA with PuA as the RSA key
17. A's applet hashes M into a 32-byte hash value which is then encrypted with PrA using RSA into a message signature (SIG). This message can only be decrypted by PuA and allows B to be certain that the message came from the person with control over PrA and that M was not tampered with in transit.
18. A's applet encrypts A2 into A2E with PuA
19. A's applet sends ME, SIG, A2, A2E, A1E, and A1EA to the message server
20. Server generates random authentication code (AUTH) and associates it with B (but not A). This step occurs when B is a non-user and is taken to assure that only the person with access to this e-mail address can create an account using this e-mail address. A similar step takes place when a new user registers on a website, without having received a message yet or without having clicked on the link in a notification e-mail. AUTH code is the same for all senders to B.
21. Server generates random ID (RID) and associates it with the account pair, A, B. [RID is unique to the sender-receiver pair, A-B in this case, but will be the same for all messages from A to B until B has registered. RID is used to tell the message server which messages to download, if A is in locally encrypting mode, and decrypt.]
22. Server stores ME and A1E with a reference to B, ME, and A1EA with a reference to A (in A's sent box) and stores A2E and RID with a reference to A and B
23. Server stores SIG with a reference to ME and A's current public key, PuA. [Emphasis added because the public key in use by A at the time of this e-mail is stored, even if the message server or application issues A a new public key later]
24. Server sends B regular SMTP e-mail with A2, RID and AUTH embedded in the link
25. B gets SMTP message in regular e-mail account
26. B clicks on A2-, RID- and AUTH-embedded link and goes to signup page
27. B enters pw and creates challenge and response Q and A and enters submit
28. Applet Loads Up in Browser
29. B's applet generates PuB and PrB
30. B's applet generates hash (user name, pw), H1B. H1B is a hash involving the user's name and password and will be used to identify the user in subsequent logins. H1B (as well as H1A) will be stored on the server.
31. B's applet generates hash (pw, pw), H2B. H2B is a hash involving the user's password twice and will be used to decrypt PrBE.
32. B's applet creates two hashes, SH1B (user name, A) and SH2B (A, A). A is the answer to the challenge question the user submitted. A is a back-up pw should person A forget his primary pw. SH1B and SH2B are analogues of H1B and H2B but use the answer to the challenge question instead of the password in case the user forgets the password. The challenge question is user-defined. SH1B will be used to verify that the user has answered the challenge response question correctly if the user fails to remember his or her password.
33. B's applet encrypts PrB into PrBE with AES and uses H2B as AES key
34. B's applet encrypts PrB into SPrBE with AES and uses SH2B as AES key (SPrBE is the Backup Encrypted Version of PrB)
35. B's applet sends PrBE, PuB, H1B, SH1B and SPrBE to server via SSL
36. Server, using AUTH embedded in link, validates B's account
37. Server stores PrBE, PuB, H1B, SH1B, and SPrBE and associates all of these with B's account
38. Using A2 embedded in link, server decrypts A1E into A1 and then reencrypts A1 into A1EB using PuB
39. B gets transferred to inbox page

Recipient Reads Message
40. B clicks on message in inbox
41. Server sends ME, A1EB (encrypted with PuB), SIG (message signature), PuA (the public key associated with A's account when A created the message) to B
42. B's applet decrypts A1EB into A1 using PrB and RSA
43. B's applet decrypts ME using A1 and AES and displays clear text message
44. B's applet decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 2: a [Subscriber, Locally Encrypting Web Mail Mode] E-Mails B [Subscriber, Locally Encrypting Web Mail Mode]

Log In
1. A enters his or her own username and password
2. A's applet hashes (user name, pw) into H1A, a 32-byte array, using SHA256 as algorithm for hash function
3. A's applet hashes (pw, pw) into H2A, a 32-byte array, using SHA256 as algorithm for hash function
4. A's applet transmits H1A to message server using http and SSL
5. Message server compares user name and H1A hash value against the stored database values
6. If successful, Message Server returns PuA and PrAE. PrA was originally encrypted using AES with H2A as the AES key at the time that A's key pair was issued, typically during registration.
7. A's applet decrypts PrAE into PrA using AES and H2A as the AES key and temporarily stores PrA and PuA in applet's memory. The data in memory is deleted when the user either logs out or closes the browser.
8. A is transferred to inbox page where he can compose message (i.e. login is complete)

Message Composition
9. A clicks compose message
10. A composes message M to B and hits “send secure”
11. A's applet transmits B's e-mail address, querying server for PuB
12. Message server finds an e-mail address which matches B's e-mail address and returns PuB
13. A's applet generates AES key A1
14. A's applet encrypts message M with A1 using AES, creating an encrypted message (ME)
15. A's applet uses RSA to encrypt A1 with PuB, creating A1EB
16. A's applet encrypts A1 into A1EA with PuA as the RSA key
17. A's applet hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit
18. A's applet sends ME, SIG, A1EB and A1EA to message server
19. Server stores ME and A1EB with a reference to B and ME and A1EA with a reference to A (in A's sent box)
20. A's applet sends A1E, ME and SIG to message server
21. Server associates A1E and ME with a reference to B and A
22. Server stores SIG with a reference to ME and A's current public key, PuA. [Emphasis added because the public key in use by A at the time of this e-mail is stored, even if the message server or application issues A a new public key later]
23. Server sends B a Regular SMTP e-mail with e-mail address embedded in the link
24. B gets SMTP message in regular e-mail account
25. B clicks on link and goes to a login page (or directly to inbox depending on recipient's security setting)
26. B enters pw (login, which is B's e-mail address, is pre-entered) [this step will not occur if user setting does not require it]
27. B's applet hashes (user name, pw) into H1B, a 32-byte array, using SHA256 as algorithm for hash function
28. B's applet transmits H1B to message server using http and SSL
29. Message server compares user name and H1B hash value against the stored database values to authenticate B's identity
30. If successful, the message server returns PuB and PrBE. The key is encrypted using AES and H2B, which is the result of hashing B's (pw, pw), as AES key.
31. B's applet decrypts PrBE into PrB using AES and H2B as the AES key and temporarily stores PrB and PuB in applet's memory. The data in memory is deleted when the user either logs out or closes the browser.
32. B is transferred to inbox page where he can compose message (i.e. login is complete).

Recipient Reads Message
33. B clicks on message in inbox
34. Server sends ME, A1EB (encrypted with PuB), SIG (message signature), PuA (the public key associated with A's account when A created the message) to B
35. B's applet decrypts A1EB into A1 using PrB and RSA
36. B's applet decrypts ME using A1 and AES and displays clear text message, M
37. B's applet decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 3: a [Subscriber, Locally Encrypting Web Mail Mode] E-Mails B [Non-Subscriber, Remotely Encrypting Web Mail Mode]

Log In
1. A enters his or her own username and password
2. A's applet hashes (user name, pw) into H1A, a 32-byte array, using SHA256 as algorithm for hash function
3. A's applet hashes (pw, pw) into H2A, a 32-byte array, using SHA256 as algorithm for hash function
4. A's applet transmits H1A to message server using http and SSL
5. Message server compares user name and H1A hash value against the stored database values
6. If successful, message server returns PuA and PrAE. The key was encrypted using AES and H2A, which is the result of hashing A's (pw, pw), as AES key.
7. A's applet decrypts PrAE into PrA using AES and H2A as the AES key and temporarily stores PrA and PuA in applet's memory. The data in memory is deleted when the user either logs out or closes the browser.
8. A is transferred to inbox page where he can compose message (i.e. login is complete).

Message Composition
9. A clicks compose message
10. A composes message M to B and hits “send secure”
11. A's applet transmits B's e-mail address, querying server for PuB
12. Server responds that there is no user with this e-mail address in the system
13. A's applet generates AES key A1
14. A's applet encrypts message M with A1 using AES, creating an encrypted message (ME)
15. A's applet generates AES key A2 and encrypts A1 into A1E with A2. A1 is encrypted so that the message server cannot decrypt ME. The message server does not store the key, A2, needed to decrypt A1E to A1 and A1 is needed to decrypt ME. If B were already in the system, instead of using A2 to encrypt A1 the system would use PuB to encrypt A1.
16. A's applet encrypts A1 into A1EA with PuA as the RSA key
17. A's applet hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit
18. A's applet encrypts A2 into A2E with PuA
19. A's applet sends ME, SIG, A2, A2E, A1E and A1EA to message server
20. Server generates random authentication code (AUTH) and associates it with B (but not A). This step occurs when B is a non-user and is taken to assure that the person with access to this e-mail address can create a message server account using this e-mail address. A similar step takes place when a new user registers on the site, without having received an e-mail from the system yet or without having clicked on the link in a notification e-mail. AUTH code is the same for all senders to B.
21. Server generates random ID (RID) and associates it with the account pair, A, B. RID is unique to the sender-receiver pair, A-B in this case, but will be the same for all messages from A to B until B has registered. RID is used to tell the message server which messages to download, if A is in locally encrypting mode, and decrypt.
22. Server stores ME and A1E with a reference to B, ME and A1EA with a reference to A (in A's sent box) and A2E and RID with a reference to A and B
23. Server stores SIG with a reference to ME and A's current public key, PuA. This is the public key in use by A at the time of this e-mail is stored, even if the message server issues A a new public key later.
24. Server sends B regular SMTP e-mail with A2, RID and AUTH embedded in the link
25. B gets SMTP message in regular e-mail account
26. B clicks on A2-, RID- and AUTH-embedded link and goes to signup page
27. B enters pw and creates challenge and response Q and A and enters submit
28. Server generates PuB and PrB. PrB remains in the message server memory for the duration of this session.
29. Server generates hash (user name, pw), H1B. H1B is a hash involving the user's name and password and will be used to identify the user in subsequent logins. H1B (as well as H1A) will be stored on the server.
30. Server generates hash (pw, pw), H2B. H2B is a hash involving the user's password twice and will be used to decrypt PrBE. H2B (as well as H2A) is never stored on the message server.
31. Server creates two hashes, SH1B (user name, A) and SH2B (A, A). A is the answer to the challenge question the user submitted. A is, in effect, a back-up pw should person A forget his primary pw. SH1B and SH2B are analogues of H1B and H2B but use the answer to the challenge question instead of the password in case the user forgets the password. SH1B will be used to verify that the user has answered the challenge response question correctly if the user fails to remember his or her password.
32. Server encrypts PrB into PrBE with AES and uses H2B as AES key
33. Server encrypts PrB into SPrBE with AES and uses SH2B as AES key (SPrBE is the backup encrypted version of PrB)
34. Server, using AUTH embedded in link, validates B's account
35. Server stores PrBE, PuB, H1B, SH1B, and SPrBE and associates all of these with B's account
36. Using A2 embedded in link, server decrypts A1E into A1 and then reencrypts A1 into A1EB using PuB
37. B gets transferred to inbox page

Recipient Reads Message
38. B clicks on encrypted message, ME.
39. Server retrieves ME, A1EB
40. Server uses RSA and PrB to decrypt A1EB into A1
41. Server decrypts ME using A1 and AES
42. Message Server decrypts the SIG with PuA, generating MHA, the hash value (for the hash of M) created by A. Message Server hashes M, as received, into MHB. If MHA=MHB, the message came from PrA and was not tampered with in transit. If not, either the message came from some other key or was tampered with.
43. If MHA=MHB, Server transmits clear text message M over SSL to B
   Scenario 4: a [Subscriber, Locally Encrypting Web Mail Mode] E-Mails B [Subscriber, Remotely Encrypting Web Mail Mode]

Log In
1. A enters his or her own username and password
2. A's applet hashes (user name, pw) into H1A, a 32-byte array, using SHA256 as algorithm for hash function
3. A's applet hashes (pw, pw) into H2A, a 32-byte array, using SHA256 as algorithm for hash function
4. A's applet transmits H1A to message server using http and SSL
5. Message server compares user name and H1A hash value against the stored database values
6. If successful, message server returns PuA and PrAE. The key was encrypted using AES and H2A, which is the result of hashing A's (pw, pw), as AES key.
7. A's applet decrypts PrAE into PrA using AES and H2A as the AES key and temporarily stores PrA and PuA in applet's memory. The data in memory is deleted when the user either logs out or closes the browser.
8. A is transferred to inbox page where he can compose message (i.e. login is complete)

Message Composition
9. A clicks compose message
10. A composes message M to B and hits “send secure”
11. A's applet transmits B's e-mail address, querying server for PuB
12. Message server finds an e-mail address which matches B's e-mail address and returns PuB
13. A's applet generates AES key A1
14. A's applet encrypts message M with A1 using AES, creating an encrypted message (ME)
15. A's applet uses RSA to encrypt A1 with PuB, creating A1EB
16. A's applet encrypts A1 into A1EA with PuA as the RSA key
17. A's applet hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit
18. A's applet sends ME, SIG, A1EB and A1EA to message server
19. Server stores ME and A1EB with a reference to B and ME and A1EA with a reference to A (in A's sent box)
20. Server associates A1E and ME with a reference to B and A
21. Server stores SIG with a reference to ME and A's current public key, PuA. The public key in use by A at the time of this e-mail is stored, even if the system issues A a new public key later.
22. Server sends B Regular SMTP e-mail with e-mail address embedded in the link
23. B gets SMTP message in regular e-mail account
24. B clicks on link and goes to a login page (or directly to inbox depending on recipient's security setting)
25. B enters pw (login, which is B's e-mail address, is pre-entered) This step will not occur if user setting does not require it.
26. B logs in and transmits username and password over SSL to server
27. Message server hashes (user name, pw) into H1B and hashes (pw, pw) into H2B, using SHA256
28. Message server compares user name and H1B hash value against the stored database values to authenticate B's identity to authenticate B's identity.
29. Message server retrieves PrBE from database.
30. Message server decrypts PrBE to PrB using H2B as the AES key. PrB remains in the message server memory for the duration of this session.

Recipient Reads Message in Remotely Encrypting Mode in Browser
31. B is transferred to inbox page where he clicks on encrypted message, ME.
32. Server retrieves ME, A1EB
33. Server uses RSA and PrB to decrypt A1EB into A1
34. Server decrypts ME using A1 and AES
35. Message Server decrypts the SIG with PuA, generating MHA, the hash value (for the hash of M) created by A. Message Server hashes M, as received, into MHB. If MHA=MHB, the message came from PrA and was not tampered with in transit. If not, either the message came from some other key or was tampered with.
36. 35. If MHA=MHB, Message Server transmits clear text message M over SSL to B
   Scenario 5: a [Subscriber, Locally Encrypting Web Mail Mode] E-Mails B [E-Mail Application User]

Log In
1. A enters his or her own username and password
2. A's applet hashes (user name, pw) into H1A, a 32-byte array, using SHA256 as algorithm for hash function
3. A's applet hashes (pw, pw) into H2A, a 32-byte array, using SHA256 as algorithm for hash function
4. A's applet transmits H1A to message server using http and SSL
5. Message server compares user name and H1A hash value against the stored database values
6. If successful, message server returns PuA and PrAE. The key was encrypted using AES and H2A, which is the result of hashing A's (pw, pw), as AES key.
7. A's applet decrypts PrAE into PrA using AES and H2A as the AES key and temporarily stores PrA and PuA in applet's memory. The data in memory is deleted when the user either logs out or closes the browser.
8. A is transferred to inbox page where he can compose message (i.e. login is complete)

Message Composition
9. A clicks compose message
10. A composes message M to B and hits “send secure”
11. A's applet transmits B's e-mail address, querying server for PuB
12. Message server finds an e-mail address which matches B's e-mail address and returns PuB
13. A's applet generates AES key A1
14. A's applet encrypts message M with A1 using AES, creating an encrypted message (ME)
15. A's applet uses RSA to encrypt A1 with PuB, creating A1EB
16. A's applet encrypts A1 into A1EA with PuA as the RSA key
17. A's applet hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
18. A's applet sends ME, SIG, A1EB and A1EA to message server
19. Server stores ME and A1EB with a reference to B and ME and A1EA with a reference to A (in A's sent box)
20. Server stores SIG with a reference to ME and A's current public key, PuA. Emphasis added because the public key in use by A at the time of this e-mail is stored.

Recipient Reads Message
21. B opens e-mail application
22. A dialog box opens, asking for pw
23. B enters pw
24. e-mail application hashes (username, pw) into H1B and queries server to login
25. Server validates login request and initiates web service session
26. B clicks send/receive to query message server for new messages, or this step could be set to occur automatically.
27. Message server returns list of new encrypted messages, each of which is in the format of ME and its unique, associated A1EB (encrypted with PuB), SIG (message signature), and PuA (the public key associated with A's account when A created the message). These are displayed in the inbox intermixed with regular SMTP e-mail messages.
28. B opens a new encrypted e-mail, ME
29. e-mail application decrypts A1EB with PrB to get A1 using RSA
30. e-mail application decrypts ME with A1 using AES and displays M
31. e-mail application plug-in decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 6: a [Subscriber, Remotely Encrypting Web Mail Mode] E-Mails B [Non-Subscriber, Locally Encrypting Web Mail Mode]

Log In
1. A transmits username and password over SSL to server
2. Message server hashes (user name, pw) into H1A and hashes (pw, pw) into H2A, using SHA256
3. Message Server compares user name and H1A hash value against the stored database values
4. If successful, Message Server retrieves PrAE from database.
5. Message server decrypts PrAE to PrA using H2A as the AES key
6. A is transferred to inbox page where he can compose message (i.e. login is complete). PrA remains in the message server memory for the duration of this session.

Message Composition
7. A clicks compose message
8. A composes message M to B and hits “send secure”
9. A's browser transmits B's e-mail address and M to message server
10. Message server business logic layer queries server database for PuB
11. Server database responds that there is no user with this e-mail address in the system
12. Server generates AES key A1
13. Server encrypts message M with A1 using AES, creating an encrypted message (ME)
14. Server generates AES key A2 and encrypts A1 into A1E with A2. A1 is encrypted so that the message server cannot decrypt ME. The message server does not store the key, A2, needed to decrypt A1E to A1 and A1 is needed to decrypt ME. If B were already in the system, instead of using A2 to encrypt A1 the system would use PuB to encrypt A1.
15. Server encrypts A1 into A1EA with PuA as the RSA key
16. Message Server hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
17. Server encrypts A2 into A2E with PuA
18. Server generates random authentication code (AUTH) and associates it with B (but not A). This step occurs only when B is a non-user and is taken to assure that only the person with access to this e-mail address can create an account on the message server using this e-mail address. A similar step takes place when a new user registers on the website, without having received a message yet or without having clicked on the link in a notification e-mail. AUTH code is the same for all senders to B.
19. Server generates random ID (RID) and associates it with the account pair, A, B. This ID is used so that if A sends subsequent messages before B has signed up, as in scenario 16 below, B just needs to click on one notification e-mail and all messages A sent will be decrypted.
20. Server stores ME and A1E with a reference to B, ME and A1EA with a reference to A (in A's sent box) and A2E and RID with a reference to A and B
21. Server stores SIG with a reference to ME and A's current public key, PuA. This refers to the public key in use by A at the time of this e-mail is stored, even if the system issues A a new public key later.
22. Server sends B regular SMTP e-mail with A2, RID and AUTH embedded in the link
23. B gets SMTP message in regular e-mail account
24. B clicks on A2-, RID- and AUTH-embedded link and goes to a signup page
25. B enters pw and creates challenge and response Q and A and enters submit
26. Applet Loads Up in Browser
27. B's applet generates PuB and PrB
28. B's applet generates hash (user name, pw), H1B. H1B is a hash involving the user's name and password and will be used to identify the user in subsequent logins. H1B (as well as H1A) will be stored on the server.
29. B's applet generates hash (pw, pw), H2B. H2B is a hash involving the user's password twice and will be used to decrypt PrBE. H2B (as well as H2A) is never stored on the message server.
30. B's applet creates two hashes, SH1B (user name, A) and SH2B (A, A). [A is the answer to the challenge question the user submitted. A is, in effect, a back-up pw should person A forget his primary pw. SH1B and SH2B are analogues of H1B and H2B but use the answer to the challenge question instead of the password in case the user forgets the password. The challenge question is user-defined and equivalent to “What is your mother's maiden name?” SH1B will be used to verify that the user has answered the challenge response question correctly if the user fails to remember his or her password.]
31. B's applet encrypts PrB into PrBE with AES and uses H2B as AES key
32. B's applet encrypts PrB into SPrBE with AES and uses SH2B as AES key (SPrBE is the Backup Encrypted Version of PrB)
33. B's applet sends PrBE, PuB, H1B, SH1B and SPrBE to server via SSL
34. Server, using AUTH embedded in link, validates B's account
35. Server stores PrBE, PuB, H1B, SH1B, and SPrBE and associates all of these with B's account
36. Using A2 embedded in link, server decrypts A1E into A1 and then reencrypts A1 into A1EB using PuB
37. B gets transferred to inbox page

Recipient Reads Message
38. B clicks on message in inbox
39. Server sends ME, A1EB (encrypted with PuB), SIG (message signature), PuA (the public key associated with A's account when A created the message) to B
40. B's applet decrypts A1EB into A1 using PrB and RSA
41. B's applet decrypts ME using A1 and AES and displays clear text message
42. B's applet decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 7: a [Subscriber, Remotely Encrypting Web Mail Mode] E-Mails B [Subscriber, Locally Encrypting Web Mail Mode]

Log In
1. A transmits username and password over SSL to server
2. Message server hashes (user name, pw) into H1A and hashes (pw, pw) into H2A, using SHA256
3. Message Server compares user name and H1A hash value against the stored database values
4. If successful, Message Server retrieves PrAE from database. PrA was originally encrypted using AES with H2A as the AES key at the time that A's key pair was issued, typically during registration.
5. Message server decrypts PrAE to PrA using H2A as the AES key
6. A is transferred to inbox page where he can compose message (i.e. login is complete). PrA remains in the message server memory for the duration of this session.

Message Composition
7. A clicks compose message
8. A composes message M to B and hits “send secure”
9. A's browser transmits B's e-mail address and M to message server
10. Message server is queried for PuB/e-mail address
11. Message Server Finds a Match
12. Message server generates AES key A1
13. Message server encrypts message M with A1 using AES, creating an encrypted message (ME)
14. Message server uses RSA to encrypt A1 with PuB, creating A1EB
15. Message server encrypts A1 into A1EA with PuA as the RSA key
16. Message Server hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
17. Server stores ME and A1EB with a reference to B and ME and A1EA with a reference to A (in A's sent box)
18. Server stores SIG with a reference to ME and A's current public key, PuA. The public key in use by A at the time of this e-mail is stored, even if the system issues A a new public key later.
19. Server sends B Regular SMTP e-mail with B's e-mail address embedded in the link
20. B gets SMTP message in regular e-mail account
21. B clicks on link and goes to login page (or directly to inbox depending on recipient's security setting)
22. B enters pw (login, which is B's e-mail address, is pre-entered) [this step will not occur if user setting does not require it]
23. B's applet hashes (user name, pw) into H1B, a 32-byte array, using SHA256 as algorithm for hash function
24. B's applet transmits H1B to message server using http and SSL
25. Message server compares user name and H1B hash value against the stored database values to authenticate B's identity to authenticate B's identity
26. If successful, message server returns PuB and PrBE. The key is encrypted using AES and H2B, which is the result of hashing B's (pw, pw), as AES key.
27. B's applet decrypts PrBE into PrB using AES and H2B as the AES key and temporarily stores PrB and PuB in applet's memory. The data in memory is deleted when the user either logs out or closes the browser.
28. B is transferred to inbox page where he can compose message (i.e. login is complete)

Recipient Reads Message
29. B clicks on message in inbox
30. Server sends ME, A1EB (encrypted with PuB), SIG (message signature), PuA (the public key associated with A's account when A created the message) to B
31. B's applet decrypts A1 EB into A1 using PrB and RSA
32. B's applet decrypts ME using A1 and AES and displays clear text message, M
33. B's applet decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 8: a [Subscriber, Remotely Encrypting Web Mail Mode] E-Mails B [Non-Subscriber, Remotely Encrypting Web Mail Mode]

Log In
1. A transmits username and password over SSL to server
2. Message server hashes (user name, pw) into H1A and hashes (pw, pw) into H2A, using SHA256
3. Message Server compares user name and H1A hash value against the stored database values
4. If successful, Message Server retrieves PrAE from database. PrA was originally encrypted using AES with H2A as the AES key at the time that A's key pair was issued, typically during registration.
5. Message server decrypts PrAE to PrA using H2A as the AES key
6. A is transferred to inbox page where he can compose message (i.e. login is complete). PrA remains in the message server memory for the duration of this session.

Message Composition
7. A clicks compose message
8. A composes message M and hits “send secure”
9. A's message is transmitted through SSL to the server
10. Server looks up B's public key (PuB) using his e-mail address
11. Message server business logic layer queries server database for PuB
12. Server database responds that there is no user with this e-mail address in the system
13. Server generates AES key (A1)
14. Server encrypts message M with A1 using AES, creating encrypted message (ME)
15. Server generates AES key A2 and encrypts A1 into A1E with A2. The system encrypts A1 so that the message server cannot decrypt ME. The message server does not store the key, A2, needed to decrypt A1E to A1 and A1 is needed to decrypt ME. If B were already in the system, instead of using A2 to encrypt A1 it would use PuB to encrypt A1.
16. Server encrypts A1 into A1EA with PuA as the RSA key
17. Message Server hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit. It is equivalent to signing an e-mail with a digital certificate.
18. Server encrypts A2 into A2E with PuA
19. Server generates random authentication code (AUTH) and associates it with B (but not A). This step occurs when B is a non-user and is taken to assure that only the person with access to this e-mail address can create an account using this e-mail address. AUTH code is the same for all senders to B.
20. Server generates random ID (RID) and associates it with the account pair, A, B. RID is unique to the sender-receiver pair, A-B in this case, but will be the same for all messages from A to B until B has registered. RID is used to tell the message server which messages to download, if A is in locally encrypting mode, and decrypt.
21. Server stores ME and A1E with a reference to B, ME and A1EA with a reference to A (in A's sent box) and A2E and RID with a reference to A and B
22. Server stores SIG with a reference to ME and A's current public key, PuA. The public key in use by A at the time of this e-mail is stored, even if the system issues A a new public key later.
23. Server sends B regular SMTP e-mail with A2, RID and AUTH embedded in the link
24. B gets SMTP message in regular e-mail account
25. B clicks on A2-, RID- and AUTH-embedded link and goes to signup page
26. B enters pw and creates challenge and response Q and A and enters submit
27. Server generates PuB and PrB. PrB remains in the message server memory for the duration of this session.
28. Server generates hash (user name, pw), H1B. H1B is a hash involving the user's name and password and will be used to identify the user in subsequent logins. H1B (as well as H1A) will be stored on the server.
29. Server generates hash (pw, pw), H2B. H2B is a hash involving the user's password twice and will be used to decrypt PrBE. H2B (as well as H2A) is never stored on the message server.
30. Server creates two hashes, SH1B (user name, A) and SH2B (A, A). A is the answer to the challenge question the user submitted. A is, in effect, a back-up pw should person A forget his primary pw. SH1B and SH2B are analogues of H1B and H2B but use the answer to the challenge question instead of the password in case the user forgets the password. SH1B will be used to verify that the user has answered the challenge response question correctly if the user fails to remember his or her password.
31. Server encrypts PrB into PrBE with AES and uses H2B as AES key
32. Server encrypts PrB into SPrBE with AES and uses SH2B as AES key (SPrBE is the backup encrypted version of PrB)
33. Server, using AUTH embedded in link, validates B's account
34. Server stores PrBE, PuB, H1B, SH1B, and SPrBE and associates all of these with B's account
35. Using A2 embedded in link, server decrypts A1EB into A1 and then reencrypts A1 into A1E using PuB
36. B gets transferred to inbox page

Recipient Reads Message
37. B clicks on encrypted message, ME.
38. Server retrieves ME, A1EB
39. Server uses RSA and PrB to decrypt A1EB into A1
40. Server decrypts ME using A1 and AES
41. Message Server decrypts the SIG with PuA, generating MHA, the hash value (for the hash of M) created by A. Message Server hashes M, as received, into MHB. If MHA=MHB, the message came from PrA and was not tampered with in transit. If not, either the message came from some other key or was tampered with.
42. If MHA=MHB, Message Server transmits clear text message M over SSL to B
   Scenario 9: a [Subscriber, Remotely Encrypting Web Mail Mode] E-Mails B [Subscriber, Remotely Encrypting Web Mail Mode]

Log In
1. A transmits username and password over SSL to server
2. Message server hashes (user name, pw) into H1A and hashes (pw, pw) into H2A, using SHA256
3. Message Server compares user name and H1A hash value against the stored database values
4. If successful, Message Server retrieves PrAE from database. PrA was originally encrypted using AES with H2A as the AES key at the time that A's key pair was issued, typically during registration.
5. Message server decrypts PrAE to PrA using H2A as the AES key
6. A is transferred to inbox page where he can compose message (i.e. login is complete). PrA remains in the message server memory for the duration of this session.

Message Composition
7. A clicks compose message
8. A composes message M to B and hits “send secure”
9. A's browser transmits B's e-mail address and M to message server
10. Message server is queried for PuB/e-mail address
11. Message Server Finds a Match
12. Message server generates AES key A1
13. Message server encrypts message M with A1 using AES, creating an encrypted message (ME)
14. Message server uses RSA to encrypt A1 with PuB, creating A1EB
15. Message server encrypts A1 into A1EA with PuA as the RSA key
16. Message Server hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
17. Server stores ME and A1EB with a reference to B and ME and A1EA with a reference to A (in A's sent box)
18. Server stores SIG with a reference to ME and A's current public key, PuA. The public key in use by A at the time of this e-mail is stored, even if the system issues A a new public key later.
19. Server sends B Regular SMTP e-mail with B's e-mail address embedded in the link
20. B gets SMTP message in regular e-mail account
21. B clicks on link and goes to login page (or directly to inbox depending on recipient's security setting)
22. B enters pw (login, which is B's e-mail address, is pre-entered) [this step will not occur if user setting does not require it]
23. B logs in and transmits username and password over SSL to server
24. Message server hashes (user name, pw) into H1B and hashes (pw, pw) into H2B, using SHA256
25. Message server compares user name and H1B hash value against the stored database values to authenticate B's identity to authenticate B's identity.
26. Message server retrieves PrBE from database.
27. Message server decrypts PrBE to PrB using H2B as the AES key. PrB remains in the message server memory for the duration of this session.

Recipient Reads Message in Remotely Encrypting Mode in Browser
28. B is transferred to inbox page where he clicks on encrypted message, ME.
29. Server retrieves ME, A1EB
30. Server uses RSA and PrB to decrypt A1EB into A1
31. Server decrypts ME using A1 and AES
32. Message Server decrypts the SIG with PuA, generating MHA, the hash value (for the hash of M) created by A. Message Server hashes M, as received, into MHB. If MHA=MHB, the message came from PrA and was not tampered with in transit. If not, either the message came from some other key or was tampered with.
33. If MHA=MHB, Message Server transmits clear text message M over SSL to B
   Scenario 10: a [Subscriber, Remotely Encrypting Web Mail Mode] E-Mails B [E-Mail Application User]

Log In
1. A transmits username and password over SSL to server
2. Message server hashes (user name, pw) into H1A and hashes (pw, pw) into H2A, using SHA256
3. Message Server compares user name and H1A hash value against the stored database values
4. If successful, Message Server retrieves PrAE from database. PrA was originally encrypted using AES with H2A as the AES key at the time that A's key pair was issued, typically during registration.
5. Message server decrypts PrAE to PrA using H2A as the AES key
6. A is transferred to inbox page where he can compose message (i.e. login is complete). PrA remains in the message server memory for the duration of this session.

Message Composition
7. A clicks compose message
8. A composes message M to B and hits “send secure”
9. A's browser transmits B's e-mail address and M to message server
10. Message server is queried for PuB/e-mail address
11. Message Server Finds a Match
12. Message server generates AES key A1
13. Message server encrypts message M with A1 using AES, creating an encrypted message (ME)
14. Message server uses RSA to encrypt A1 with PuB, creating A1EB
15. Message server encrypts A1 into A1EA with PuA as the RSA key
16. Message Server hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
17. Server stores ME and A1EB with a reference to B and ME and A1EA with a reference to A (in A's sent box)
18. Server stores SIG with a reference to ME and A's current public key, PuA. The public key in use by A at the time of this e-mail is stored, even if the system issues A a new public key later.

Recipient Reads Message
19. B opens e-mail application
20. Dialog box opens, asking for pw
21. B enters pw
22. e-mail application hashes (username, pw) into H1B and queries server to login
23. Server validates login request and initiates web service session
24. B clicks send/receive to query message server for new messages (or this step could be set to occur automatically)
25. Message server returns list of new encrypted messages, each of which is in the format of ME and its unique, associated A1EB (encrypted with PuB), SIG (message signature), and PuA, the public key associated with A's account when A created the message. These are displayed in the inbox intermixed with regular SMTP e-mail messages.
26. B opens a new encrypted e-mail, ME
27. e-mail application decrypts A1EB with PrB to get A1 using RSA
28. e-mail application decrypts ME with A1 using AES and displays M
29. e-mail application plug-in decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 11: a [E-Mail Application User] E-Mails B [Non-Subscriber, Locally Encrypting Web Mail Mode]

Log In
1. A opens e-mail application
2. If A has configured e-mail application to accept e-mail application pw for message server pw, then skip to next step. If not, message server dialog box opens, asking for pw which A enters
3. A's e-mail application plug-in hashes (user name, pw) into H1A, a 32-byte array, using SHA256 as algorithm for hash function
4. A's e-mail application plug-in hashes (pw, pw) into H2A, a 32-byte array, using SHA256 as algorithm for hash function
5.
   a. If A is offline:
      i. A's e-mail application plug-in decrypts PrAE (stored on client) into PrA using AES and H2A as the AES key and temporarily stores PrA and PuA in plug-in's memory.
   b. If/Once A is online:
      i. A's e-mail application plug-in transmits H1A to Message Server using http and SSL
      ii. Message Server compares user name and H1A hash value against the stored database values
      iii. If successful, A is logged in and Message Server returns PuA and PrAE. PrA key was originally encrypted at the time that A's key pair was issued, typically during registration, using AES with H2A as the AES key.
      iv. A's e-mail application plug-in decrypts PrAE into PrA using AES and H2A as the AES key and temporarily stores PrA and PuA in plug-in's memory.
      v. PrA and PuA from Message Server are compared to PrA and PuA which have been stored on client; if different, new key pair becomes active key pair and previous key pair is stored to open message which they encrypted.

Message Composition
6. A clicks compose message
7. A composes message and hits “send secure”
8. A's plug-in generates AES key A1 and encrypts M into ME with A1 using AES
9. A's plug-in encrypts A1 into A1EA with PuA as the RSA key
10. A's plug-in hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
11. ME and A1EA are stored in outbox (to be placed in sent box once A goes on-line and message is sent)

Once Online:
12. A's plug-in transmits B's e-mail address, querying server for PuB
13. Server responds that there is no user with this e-mail address in the system
14. A's plug-in generates AES key A1 and encrypts M into ME with A1 using AES
15. A's plug-in generates AES key A2 and encrypts A1 into A1E with A2. A1 is encrypted so that the message server cannot decrypt ME. The message server does not store the key, A2, needed to decrypt A1E to A1 and A1 is needed to decrypt ME. If B were already in the system, instead of using A2 to encrypt A1 the system would use PuB to encrypt A1.
16. A's plug-in encrypts A2 into A2E with PuA.
17. A's plug-in sends ME, SIG, A2, A2E, A1E and A1EA to message server
18. Server generates random authentication code (AUTH) and associates it with B (but not A). This step occurs only when B is a non-user and is taken to assure that only the person with access to this e-mail address can create an account using this e-mail address. AUTH code is the same for all senders to B.
19. Server generates random ID (RID) and associates it with the account pair, A, B. RID is unique to the sender-receiver pair, A-B in this case, but will be the same for all messages from A to B until B has registered. RID is used to tell the message server which messages to download, if A is in locally encrypting mode, and decrypt.
20. Server stores ME and A1E with a reference to B, ME and A1EA with a reference to A (in A's sent box) and A2E and RID with a reference to A and B
21. Server stores SIG with a reference to ME and A's current public key, PuA. The public key in use by A at the time of this e-mail is stored, even if the system issues A a new public key later.
22. Server sends B regular SMTP e-mail with A2, RID and AUTH embedded in the link
23. B gets SMTP message in regular e-mail account
24. B clicks on A2-, RID- and AUTH-embedded link and goes to signup page
25. B enters pw and creates challenge and response Q and A and enters submit
26. Applet Loads Up in Browser
27. B's applet generates PuB and PrB
28. B's applet generates hash (user name, pw), H1B. H1B is a hash involving the user's name and password and will be used to identify the user in subsequent logins. H1B (as well as H1A) will be stored on the server.
29. B's applet generates hash (pw, pw), H2B. H2B is a hash involving the user's password twice and will be used to decrypt PrBE. H2B (as well as H2A) is never stored on the message server.
30. B's applet creates two hashes, SH1B (user name, A) and SH2B (A, A). A is the answer to the challenge question the user submitted. A is, in effect, a back-up pw should person A forget his primary pw. SH1B and SH2B are analogues of H1B and H2B but use the answer to the challenge question instead of the password in case the user forgets the password. SH1B will be used to verify that the user has answered the challenge response question correctly if the user fails to remember his or her password.
31. B's applet encrypts PrB into PrBE with AES and uses H2B as AES key
32. B's applet encrypts PrB into SPrBE with AES and uses SH2B as AES key (SPrBE is the Backup Encrypted Version of PrB)
33. B's applet sends PrBE, PuB, H1B, SH1B and SPrBE to server via SSL
34. Server, using AUTH embedded in link, validates B's account
35. Server stores PrBE, PuB, H1B, SH1B, and SPrBE and associates all of these with B's account
36. Using A2 embedded in link, server decrypts A1E into A1 and then reencrypts A1 into A1EB using PuB
37. B gets transferred to inbox page

Recipient Reads Message
38. B clicks on message in inbox
39. Server sends ME, A1EB (encrypted with PuB), SIG (message signature), PuA (the public key associated with A's account when A created the message) to B
40. B's applet decrypts A1EB into A1 using PrB and RSA
41. B's applet decrypts ME using A1 and AES and displays clear text message
42. B's applet decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 12: a [E-Mail Application User] E-Mails B [Subscriber, Locally Encrypting Web Mail Mode]

Log In
1. A opens e-mail application
2. If A has configured settings to accept e-mail application pw for system pw, then skip to next step. If not, dialog box opens, asking for pw which A enters
3. A's e-mail application plug-in hashes (user name, pw) into H1A, a 32-byte array, using SHA256 as algorithm for hash function
4. A's e-mail application plug-in hashes (pw, pw) into H2A, a 32-byte array, using SHA256 as algorithm for hash function
5.
   a. If A is offline:
      i. A's e-mail application plug-in decrypts PrAE (stored on client) into PrA using AES and H2A as the AES key and temporarily stores PrA and PuA in plug-in's memory.
   b. If/Once A is online:
      i. A's e-mail application plug-in transmits H1A to Message Server using http and SSL
      ii. Message Server compares user name and H1A hash value against the stored database values
      iii. If successful, A is logged in and Message Server returns PuA and PrAE. PrA key was originally encrypted at the time that A's key pair was issued, typically during registration, using AES with H2A as the AES key
         iv. A's e-mail application plug-in decrypts PrAE into PrA using AES and H2A as the AES key and temporarily stores PrA and PuA in plug-in's memory.
         v. PrA and PuA from Message Server are compared to PrA and

PuA which have been stored on client; if different, new key pair becomes active key pair and previous key pair is stored to open message which they encrypted.

Message Composition
6. A clicks compose message
7. A composes message and hits “send secure”
8. A's plug-in generates AES key A1 and encrypts M into ME with A1 using AES
9. A's plug-in encrypts A1 into A1EA with PuA as the RSA key
10. A's plug-in hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
11. ME and A1EA are stored in outbox (to be placed in sent box once A goes on-line and message is sent)

If/Once Online, the Following Steps Take Place
12. A's plug-in transmits B's e-mail address, querying server for PuB
13. Message server finds an e-mail address which matches B's e-mail address and returns PuB
14. A's plug-in uses RSA to encrypt A1 with PuB, creating A1EB
15. A's plug-in sends ME, SIG, A1EB and A1EA to message server
16. Server stores ME and A1EB with a reference to B and ME and A1EA with a reference to A (in A's sent box)
17. Server stores SIG with a reference to ME and A's current public key, PuA. The public key in use by A at the time of this e-mail is stored, even if the system issues A a new public key later.
18. Server sends B Regular SMTP e-mail with B's e-mail address embedded in the link
19. B gets SMTP message in regular e-mail account
20. B clicks on link and goes to login page (or directly to inbox depending on recipient's security setting)
21. B enters pw (login, which is B's e-mail address, is pre-entered) (optional)
22. B's applet hashes (user name, pw) into H1B, a 32-byte array, using SHA256 as algorithm for hash function
23. B's applet transmits H1B to message server using http and SSL
24. Message server compares user name and H1B hash value against the stored database values to authenticate B's identity to authenticate B's identity
25. If successful, message server returns PuB and PrBE. The key is encrypted using AES and H2B, which is the result of hashing B's (pw, pw), as AES key.
26. B's applet decrypts PrBE into PrB using AES and H2B as the AES key and temporarily stores PrB and PuB in applet's memory. The data in memory is deleted when the user either logs out or closes the browser.
27. B is transferred to inbox page where he can compose message (i.e. login is complete)

Recipient Reads Message
28. B clicks on message in inbox
29. Server sends ME, A1EB (encrypted with PuB), SIG (message signature), PuA (the public key associated with A's account when A created the message) to B
30. B's applet decrypts A1EB into A1 using PrB and RSA
31. B's applet decrypts ME using A1 and AES and displays clear text message, M
32. B's applet decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 13: a [E-Mail Application User] E-Mails B [Non-User, Remotely Encrypting Web Mail Mode]

Log In
1. A opens e-mail application
2. If A has configured e-mail application to accept e-mail application pw for system pw, then skip to next step. If not, dialog box opens, asking for pw which A enters
3. A's e-mail application plug-in hashes (user name, pw) into H1A, a 32-byte array, using SHA256 as algorithm for hash function
4. A's e-mail application plug-in hashes (pw, pw) into H2A, a 32-byte array, using SHA256 as algorithm for hash function
5.
   a. If A is offline:
      i. A's e-mail application plug-in decrypts PrAE (stored on client) into PrA using AES and H2A as the AES key and temporarily stores PrA and PuA in plug-in's memory.
   b. If/Once A is online:
      i. A's e-mail application plug-in transmits H1A to Message Server using http and SSL
      ii. Message Server compares user name and H1A hash value against the stored database values
      iii. If successful, A is logged in and Message Server returns PuA and PrAE. PrA key was originally encrypted at the time that A's key pair was issued, typically during registration, using AES with H2A as the AES key
      iv. A's e-mail application plug-in decrypts PrAE into PrA using AES and H2A as the AES key and temporarily stores PrA and PuA in plug-in's memory.
      v. PrA and PuA from Message Server are compared to PrA and

PuA which have been stored on client; if different, new key pair becomes active key pair and previous key pair is stored to open message which they encrypted

Message Composition
6. A clicks compose message
7. A composes message and hits “send secure”
8. A's plug-in generates AES key A1 and encrypts M into ME with A1 using AES
9. A's plug-in encrypts A1 into A1EA with PuA as the RSA key
10. A's plug-in hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
11. ME and A1EA are stored in outbox (to be placed in sent box once A goes on-line and message is sent)

If/Once Online, the Following Steps Take Place
12. A's plug-in transmits B's e-mail address, querying server for PuB
13. Server responds that there is no user with this e-mail address in the system
14. A's plug-in generates AES key A1 and encrypts M into ME with A1 using AES
15. A's plug-in generates AES key A2 and encrypts A1 into A1E with A2. The system encrypts A1 so that the message server cannot decrypt ME. The message server does not store the key, A2, needed to decrypt A1E to A1 and A1 is needed to decrypt ME. If B were already in the system, instead of using A2 to encrypt A1 the system would use PuB to encrypt A1.
16. A's plug-in encrypts A2 into A2E with PuA
17. A's plug-in sends ME, SIG, A2, A2E, A1E and A1EA to message server
18. Server generates random authentication code (AUTH) and associates it with B (but not A). This step occurs when B is a non-user and is taken to assure that only the person with access to this e-mail address can create an account using this e-mail address. AUTH code is the same for all senders to B.
19. Server generates random ID (RID) and associates it with the account pair, A, B. RID is unique to the sender-receiver pair, A-B in this case, but will be the same for all messages from A to B until B has registered. RID is used to tell the message server which messages to download, if A is in locally encrypting mode, and decrypt.
20. Server stores ME and A1E with a reference to B, ME and A1EA with a reference to A (in A's sent box) and A2E and RID with a reference to A and B
21. Server stores SIG with a reference to ME and A's current public key, PuA. The public key in use by A at the time of this e-mail is stored, even if the system issues A a new public key later.
22. Server sends B regular SMTP e-mail with A2, RID and AUTH embedded in the link
23. B gets SMTP message in regular e-mail account
24. B clicks on A2-, RID- and AUTH-embedded link and goes to signup page
25. B enters pw and creates challenge and response Q and A and enters submit
26. Server generates PuB and PrB. PrB remains in the message server memory for the duration of this session.
27. Server generates hash (user name, pw), H1B. H1B is a hash involving the user's name and password and will be used to identify the user in subsequent logins. H1B (as well as H1A) will be stored on the server.
28. Server generates hash (pw, pw), H2B. H2B is a hash involving the user's password twice and will be used to decrypt PrBE. H2B (as well as H2A) is never stored on the message server.
29. Server creates two hashes, SH1B (user name, A) and SH2B (A, A). A is the answer to the challenge question the user submitted. A is, in effect, a back-up pw should person A forget his primary pw. SH1B and SH2B are analogues of H1B and H2B but use the answer to the challenge question instead of the password in case the user forgets the password. The challenge question is user-defined and equivalent to “What is your mother's maiden name?” SH1B will be used to verify that the user has answered the challenge response question correctly if the user fails to remember his or her password.
30. Server encrypts PrB into PrBE with AES and uses H2B as AES key
31. Server encrypts PrB into SPrBE with AES and uses SH2B as AES key (SPrBE is the backup encrypted version of PrB)
32. Server, using AUTH embedded in link, validates B's account
33. Server stores PrBE, PuB, H1B, SH1B, and SPrBE and associates all of these with B's account
34. Using A2 embedded in link, server decrypts A1E into A1 and then reencrypts A1 into A1EB using PuB
35. B gets transferred to inbox page

Recipient Reads Message
36. B clicks on encrypted message, ME.
37. Server retrieves ME, A1EB
38. Server uses RSA and PrB to decrypt A1EB into A1
39. Server decrypts ME using A1 and AES
40. Message Server decrypts the SIG with PuA, generating MHA, the hash value (for the hash of M) created by A. Message Server hashes M, as received, into MHB. If MHA=MHB, the message came from PrA and was not tampered with in transit. If not, either the message came from some other key or was tampered with.
41. If MHA=MHB, Message Server transmits clear text message M over SSL to B
   Scenario 14: a [E-Mail Application User] E-Mails B [Subscriber, Remotely Encrypting Web Mail Mode]

Log In
1. A opens e-mail application
2. If A has configured e-mail application to accept e-mail application pw for system pw, then skip to next step. If not, dialog box opens, asking for pw which A enters
3. A's e-mail application plug-in hashes (user name, pw) into H1A, a 32-byte array, using SHA256 as algorithm for hash function
4. A's e-mail application plug-in hashes (pw, pw) into H2A, a 32-byte array, using SHA256 as algorithm for hash function
5.
   a. If A is offline:
      i. A's e-mail application plug-in decrypts PrAE (stored on client) into PrA using AES and H2A as the AES key and temporarily stores PrA and PuA in plug-in's memory.
   b. If/Once A is online:
      i. A's e-mail application plug-in transmits H1A to Message Server using http and SSL
      ii. Message Server compares user name and H1A hash value against the stored database values
      iii. If successful, A is logged in and Message Server returns PuA and PrAE. PrA key was originally encrypted at the time that A's key pair was issued, typically during registration, using AES with H2A as the AES key.
      iv. A's e-mail application plug-in decrypts PrAE into PrA using AES and H2A as the AES key and temporarily stores PrA and PuA in plug-in's memory.
      v. PrA and PuA from Message Server are compared to PrA and

PuA which have been stored on client; if different, new key pair becomes active key pair and previous key pair is stored to open message which they encrypted

Message Composition
6. A clicks compose message
7. A composes message M and hits “send secure”
8. A's plug-in generates AES key A1 and encrypts M into ME with A1 using AES
9. A's plug-in encrypts A1 into A1EA with PuA as the RSA key
10. A's plug-in hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
11. ME and A1EA are stored in outbox (to be placed in sent box once A goes on-line and message is sent)

If/Once Online, the Following Steps Take Place
12. A's plug-in transmits B's e-mail address, querying server for PuB
13. Message server finds an e-mail address which matches B's e-mail address and returns PuB
14. A's plug-in uses RSA to encrypt A1 with PuB, creating A1EB
15. A's plug-in sends ME, SIG, A1EB and A1EA to message server
16. Server stores ME and A1EB with a reference to B and ME and A1EA with a reference to A (in A's sent box)
17. Server stores SIG with a reference to ME and A's current public key, PuA. The public key in use by A at the time of this e-mail is stored, even if the system issues A a new public key later.
18. Server sends B Regular SMTP e-mail with B's e-mail address embedded in the link
19. B gets SMTP message in regular e-mail account
20. B clicks on link and goes to login page (or directly to inbox depending on recipient's security setting)
21. B enters pw (login, which is B's e-mail address, is pre-entered) (optional)
22. B logs in and transmits username and password over SSL to server
23. Message server hashes (user name, pw) into H1B and hashes (pw, pw) into H2B, using SHA256
24. Message server compares user name and H1B hash value against the stored database values to authenticate B's identity to authenticate B's identity.
25. Message server retrieves PrBE from database.
26. Message server decrypts PrBE to PrB using H2B as the AES key. PrB remains in the message server memory for the duration of this session.

Recipient Reads Message in Remotely Encrypting Mode in Browser
27. B is transferred to inbox page where he clicks on encrypted message, ME.
28. Server retrieves ME, A1EB
29. Server uses RSA and PrB to decrypt A1EB into A1
30. Server decrypts ME using A1 and AES
31. Message Server decrypts the SIG with PuA, generating MHA, the hash value (for the hash of M) created by A. Message Server hashes M, as received, into MHB. If MHA=MHB, the message came from PrA and was not tampered with in transit. If not, either the message came from some other key or was tampered with.
25. If MHA=MHB, Message Server transmits clear text message M over SSL to B
   Scenario 15: a [E-Mail Application User] E-Mails B [E-Mail Application User]

Log In
1. A opens e-mail application
2. If A has configured e-mail application to accept e-mail application pw for system pw, then skip to next step. If not, dialog box opens, asking for pw which A enters
3. A's e-mail application plug-in hashes (user name, pw) into H1A, a 32-byte array, using SHA256 as algorithm for hash function
4. A's e-mail application plug-in hashes (pw, pw) into H2A, a 32-byte array, using SHA256 as algorithm for hash function
5.
   a. If A is offline:
      i. A's e-mail application plug-in decrypts PrAE (stored on client) into PrA using AES and H2A as the AES key and temporarily stores PrA and PuA in plug-in's memory.
   b. If/Once A is online:
      i. A's e-mail application plug-in transmits H1A to Message Server using http and SSL
      ii. Message Server compares user name and H1A hash value against the stored database values
      iii. If successful, A is logged in and Message Server returns PuA and PrAE. PrA key was originally encrypted at the time that A's key pair was issued, typically during registration, using AES with H2A as the AES key.
      iv. A's e-mail application plug-in decrypts PrAE into PrA using AES and H2A as the AES key and temporarily stores PrA and PuA in plug-in's memory.
      v. PrA and PuA from Message Server are compared to PrA and

PuA which have been stored on client; if different, new key pair becomes active key pair and previous key pair is stored to open message which they encrypted

Message Composition
6. A clicks compose message
7. A composes message M and hits “send secure”
8. A's plug-in generates AES key A1 and encrypts M into ME with A1 using AES
9. A's plug-in encrypts A1 into A1EA with PuA as the RSA key
10. A's plug-in hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
11. ME and A1EA are stored in outbox (to be placed in sent box once A goes on-line and message is sent)

If/Once Online, the Following Steps Take Place
12. A's plug-in transmits B's e-mail address, querying server for PuB
13. Message server finds an e-mail address which matches B's e-mail address and returns PuB
14. A's plug-in uses RSA to encrypt A1 with PuB, creating A1EB
15. A's plug-in sends ME, SIG, A1EB and A1EA to message server
16. Server stores ME and A1EB with a reference to B and ME and A1EA with a reference to A (in A's sent box)
17. Server stores SIG with a reference to ME and A's current public key, PuA. The public key in use by A at the time of this e-mail is stored, even if the system issues A a new public key later.

Recipient Reads Message
18. B opens e-mail application
19. Dialog box opens, asking for pw
20. B enters pw
21. e-mail application hashes (username, pw) into H1B and queries server to login
22. Server validates login request and initiates web service session
23. B clicks send/receive to query message server for new messages (or this step could be set to occur automatically)
24. Message server returns list of new encrypted messages, each of which is in the format of ME and its unique, associated A1EB (encrypted with PuB), SIG (message signature), and PuA, the public key associated with A's account when A created the message. These are displayed in the inbox intermixed with regular SMTP e-mail messages.
25. B opens a new encrypted e-mail, ME
26. e-mail application decrypts A1EB with PrB to get A1 using RSA
27. e-mail application decrypts ME with A1 using AES and displays M
28. e-mail application plug-in decrypts the SIG with PuA, generating MHA, the hash value (for the hash of M) created by A. B's applet hashes M, as received, into MHB. If MHA=MHB, the message came from PrA and was not tampered with in transit. If not, either the message came from some other key or was tampered with.
   Scenario 16: a [Subscriber, Locally Encrypting Web Mail Mode] E-Mails 2^{Nd} and Subsequent Messages B [Non-Subscriber, Locally Encrypting Web Mail Mode]

Log In
1. A enters his or her own username and password
2. A's applet hashes (user name, pw) into H1A, a 32-byte array, using SHA256 as algorithm for hash function
3. A's applet transmits H1A to message server using http and SSL
4. Message server compares user name and H1A hash value against the stored database values
5. If successful, message server returns PuA and PrAE, encrypted using AES and H2A, which is the result of hashing A's (pw, pw), as AES key.
6. A's applet decrypts PrAE into PrA using AES and H2A as the AES key and temporarily stores PrA and PuA in applet's memory. The data in memory is deleted when the user either logs out or closes the browser.
7. A is transferred to inbox page where he can compose message (i.e. login is complete)

2^{nd} or Further Subsequent Message Composition
8. A composes message M to B and hits “send secure”
9. A's applet transmits B's e-mail address, querying server for PuB
10. Server responds that B doesn't exist, but that A has previously sent B a message before and returns A2E (A2E is the encrypted version of A2 the AES key that was generated to encrypt A1, A2E is encrypted using A's public key and RSA)
11. A's applet decrypts A2E using A's private key and RSA and gets A2
12. A's applet generates AES key (A1′) and encrypts message (ME) with A1′
13. A's applet encrypts (A1′) with A2 (A1′E)
14. A's applet encrypts A1′ into A1′EA with PuA as the RSA key
15. A's applet hashes M into a 32-byte hash value, MHA, which is then encrypted with PrA using RSA into a message signature (SIG). The SIG can be decrypted by PuA and allows B to be ascertain that M came from the person with control over PrA and that M was not tampered with in transit.
16. A's applet sends ME, SIG, A2, A2E, A1′E and A1′EA to message server
17. Server retrieves authentication code (AUTH) and Random Id (RID) associated with B and the pair A, B
18. Server stores ME and A1′E with a reference to B, ME and A1′EA with a reference to A (in A's sent box) and A2E and RID with a reference to A and B
19. Server stores SIG with a reference to ME and A's current public key. The public key in use by A at the time of this e-mail is stored, even if the system issues A a new public key later.
20. Server sends B Regular SMTP e-mail with A2, RID and AUTH embedded in the link
21. B gets SMTP message in regular e-mail account
22. B clicks on A2, RID- and AUTH-embedded link and goes to signup page. B can click on any previous e-mail B has received from A and it will have the same effect since all e-mails contain the same link.
23. B enters pw and creates challenge and response Q and A and enters submit
24. Unsigned applet loads up in browser
25. B's applet generates PuB and PrB
26. B's applet hashes (user name, pw) into H1B. H1B will be used to identify the user in subsequent logins.
27. B's applet hashes (pw, pw) into H2B
28. B's applet creates two hashes (user name, A) SH1B (SH1B will be used to verify that the user has answered the challenge response question correctly if the user fails to remember his or her password) and (A, A) SH2B where A is the answer to the challenge question the user submitted. A is, in effect, a back-up pw should person A forget his primary pw.
29. B's applet encrypts Pr with AES and uses H2B as AES key (PrE is encrypted version of Pr)
30. B's applet encrypts Pr with AES and uses SH2B as AES) (SPrE is the backup encrypted version of Pr)
31. B's applet sends PrE, Pu, H1B, SH1B to server via SSL
32. Server, using AUTH embedded in link, validates B's account
33. Server stores PrE, Pu, and H1B, SH1B, SPrE and associates all of these with B's account
34. Using RID embedded in link, server searches for all messages A has sent to B and retrieves each message and its associated A1E, decrypts A1E using the associated A2 embedded in link, and then reencrypts A1 using PuB and RSA into A2EB
35. B gets transferred to inbox page

Recipient Reads Message
36. B clicks on message in inbox
37. Server sends ME, A1EB (encrypted with PuB), SIG (message signature), PuA (the public key associated with A's account when A created the message) to B
38. B's applet decrypts A1EB into A1 using PrB and RSA
39. B's applet decrypts ME using A1 and AES and displays clear text message
40. B's applet verifies message signature (SIG) using M and PuA (this is to truly authenticate that the message was sent using A's account)

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of secure messaging between a sender and a recipient, the method comprising:
generating a first key associated with the sender;
encrypting a message from the sender to the recipient using the first key;
encrypting the first key with a second key;
storing the encrypted message and the encrypted first key at a message server, the message server accessible to individuals other than the sender and the recipient;
associating the encrypted message with a sender and a recipient;
decrypting the encrypted first key using a key related to the second key; and
decrypting the encrypted message using the first key;
wherein the message is encrypted on the message server at least while not accessed by the recipient or the sender.

2. The method of claim 1, wherein the recipient is a non-subscribing user of the message server.

3. The method of claim 2, wherein the second key is a second key associated with the sender.

4. The method of claim 3, wherein the key related to the second key is the second key, and is symmetric to the first key.

5. The method of claim 3, further comprising, upon decrypting the first key using the key related to the second key, encrypting the message using a recipient public key.

6. The method of claim 5, further comprising decrypting the first key using a recipient private key.

7. The method of claim 1, wherein the recipient is a subscribing user of the message server.

8. The method of claim 6, wherein the second key is a recipient public key.

9. The method of claim 1, further comprising generating a message signature.

10. The method of claim 9, wherein associating the message with a sender and a recipient further comprises associating the message signature with the message.

11. The method of claim 9, wherein associating the message with a sender and a recipient further comprises associating the message signature with the sender's public key.

12. The method of claim 1, further comprising, upon the recipient accessing the message, generating a confirmation message.

13. The method of claim 1, further comprising verifying the message signature.

14. The method of claim 1, wherein encrypting the message uses an AES encryption standard.

15. The method of claim 1, wherein decrypting the message uses an AES encryption standard.

16. The method of claim 1, wherein decrypting the first key uses an RSA decryption standard.

17. A message server accessible to individuals including a sender and a recipient, the message server comprising:
a memory configured to store one or more messages and encryption keys;
a programmable circuit operatively connected to the memory and arranged to manage messages between at least one sender and at least one recipient, the programmable circuit programmed to:
generate a first key associated with the sender;
encrypt a message from the sender to the recipient using the first key;
encrypt the first key with a second key;
store the encrypted message and the encrypted first key;
associate the encrypted message with a sender and a recipient;
decrypt the encrypted first key using a key related to the second key; and
decrypt the encrypted message using the first key;
wherein the message is encrypted on the message server at least while not accessed by the recipient or the sender.

18. The message server of claim 17, wherein the programmable circuit is further programmed to generate a message signature.

19. The message server of claim 18, wherein the programmable circuit is further programmed to associate the message signature with the message.

20. The message server of claim 18, wherein the programmable circuit is further programmed to associate the message signature with the sender's public key.

21. The message server of claim 17, wherein the recipient is a non-subscribing user of the message server.

22. The message server of claim 21, wherein the second key is a second key associated with the sender.

23. The message server of claim 22, wherein the programmable circuit is further programmed to, upon decrypting the key using the key related to the second key, encrypt the message with a recipient public key.

24. The message server of claim 17, wherein the recipient is a subscribing user of the message server.

25. The message server of claim 24, wherein the second key is a recipient public key.

26. The message server of claim 17, wherein the message server is configured to receive messages from an e-mail application running on a client computer.

27. The message server of claim 17, wherein the message server is configured to receive messages from a web application running on a client computer.

28. A method of secure messaging between a sender and an unregistered recipient, the method comprising:
generating a first key associated with the sender;
encrypting a message from the sender to the recipient using the first key;
encrypting the first sender key with a second sender key;
storing the encrypted message and the encrypted first key at a message server, the message server accessible to individuals other than the sender and the recipient;
generating a message signature;
associating the encrypted message with a sender and a recipient;
associating the message signature with the encrypted message;
decrypting the encrypted first key using a key related to the second sender key;
encrypting the first key using a recipient public key;
decrypting the encrypted first key using a recipient private key;
decrypting the encrypted message using the first key;
verifying the message signature;
wherein the message is encrypted on the message server at least while not accessed by the recipient or the sender.
